(19) United States
(12) Patent Application Publication
(10) Pub. No.: US 2026/0001724 A1
(43) Pub. Date: Jan. 1, 2026

(54) CUSTOMIZABLE COVER FOR USE WITH CONVEYOR AND RELATED METHODS

(71) Applicant: SPAN TECH LLC, Glasgow, KY (US)

(72) Inventor: Nathan LASLEY, Bowling Green, KY (US)

(21) Appl. No.: 19/116,705

(22) PCT Filed: Oct. 10, 2023
(86) PCT No.: PCT/US2023/076412

§ 371 Date: Mar. 28, 2025

Related U.S. Application Data
(60) Provisional application No. 63/414,609, filed on Oct. 10, 2022.

(51) Int. Cl. B65G 21/08; B65G 21/20

(52) U.S. Cl. CPC B65G 21/08; B65G 21/2072

(57) ABSTRACT

A cover is configured for covering conveyor component, such as a support for a guiderail for guiding one or more articles during conveyance. The support may comprise a portion of an actuator for actuating the guide rail to move in a direction transverse to a conveying direction. The cover may include a plurality of segments adapted to interconnect and articulate relative to one another, such as for assuming a straight and/or curved configuration, or a particular length of cover. Related methods are also disclosed.

This application claims the benefit of U.S. Provisional Patent Application Ser. No. 63/414,609, filed Oct. 10, 2022, the disclosure of which is incorporated herein by reference.

### TECHNICAL FIELD

This disclosure relates to the article conveying arts and, in particular, to a customizable cover for use in connection with conveyor components and related methods.

### BACKGROUND

Conveyors typically have guiderails positioned along each side of the conveyor chain or belt to guide an article along a conveying path. Articles travel between the guiderails, which are positioned to ensure that the articles remain on the conveying path. When a larger or smaller article is conveyed, or the width of the conveying path otherwise needs to be adjusted to accommodate an increased or reduced article flow, the guiderails must be adjusted to fit the situation.

Guiderail adjustment systems may employ actuators that extend and retract in response to shuttles being driven along a support rail to alter the distance between the guiderails. A desire exists to at least partially cover the actuator or other support parts to forestall contamination that could affect performance. A solid, monolithic cover could be used for this purpose, but the resulting cost in manufacture and assembly would be considerable. This is in part due to the need to form the cover in a manner that corresponds to a specific conveyor layout, which usually comprises various straight and curved sections. Further, such a cover lacks the ability to articulate.

Accordingly, a need is identified for a cover arrangement that overcomes the foregoing limitations and possibly other problems that have yet to be realized. The cover would be readily customizable, such as in terms of both length and orientation. This would allow for efficient use in connection with a variety of conveyor layouts without a significant increase in cost or complexity.

### SUMMARY

According to a first aspect of this disclosure, an apparatus includes a conveyor with a conveying surface for conveying one or more articles in a conveying direction and a guide rail for guiding the one or more articles during conveyance. A support is provided for supporting the guide rail relative to the conveying surface. A cover is also provided for at least partially covering the support, the cover comprising a plurality of interconnected segments configured for articulable movement relative to one another.

In one embodiment, adjacent segments of the plurality of segments overlap one another, and the plurality of segments may couple to one another by an interference fit. This interference fit may include a male part and a female part, with the male part provided on a first segment and the female part provided an adjacent segment to create the ability for articulated movement of the first segment relative to the second segment. In one example, the male part is provided by a protrusion extending outwardly from a wall of the first segment, and the female part is provided by an opening in a wall of the second segment, wherein the protrusion is configured for a snap-fit engagement in the opening.

The wall may include an intermediate region having opposite edges extending between opposite end regions, which may extend in an inclined relation from the intermediate region. The protrusion and the opening may be formed in the intermediate region. The intermediate region and the opposite end region of the first segment may be configured in nested relation with the intermediate region and the opposite end region of the second segment.

In these or other embodiments, each of the plurality of segments is generally C-shaped. These segments may also be adapted for assuming a first position in alignment along a straight axis to form an at least partially straight cover, and the plurality of segments are articulable relative to one another to form at least a portion of the cover extending along an arcuate path. The arcuate path may be a circular arc. The plurality of segments may be articulable relative to one another to a maximum extent in a first direction to form the circular arc having a first radius of curvature, and articulated relative to one another to a maximum extent in a second direction, opposite the first direction, to form the circular arc having a second, different radius of curvature. The opposite edges of the intermediate region may converge toward one of the opposite end regions.

At least some the plurality of segments have at least one connector to facilitate connecting the cover in overlying relation to the support. The at least one connector may comprise a snap-fit connector, which may include a pair of spring clips. One of spring clips may form a lost-motion attachment.

In any of the foregoing embodiments or otherwise, the support may comprise at least a portion of an actuator for both supporting and actuating the guiderail for movement transverse to the conveying direction.

According to a further aspect of the disclosure, an apparatus for a conveyor including a conveying surface for conveying one or more articles in a conveying direction and associated with a guide rail for guiding the one or more articles and a support for supporting the guide rail relative to the conveying surface includes a cover for at least partially covering the support, the cover comprising a plurality of interconnected segments adapted for articulable movement relative to one another.

Still a further aspect of the disclosure relates to a method of covering a support for supporting a guide rail of a conveyor. The method comprises at least partially covering the support with a cover having a plurality of segments coupled to one another. The method further comprises articulating at least one of the plurality of segments relative to another to route the cover over an arcuate path. The method may further include articulating the at least some of the plurality of segments relative to one another about a pivot axis (horizontal or vertical) formed by an interference fit that couples adjacent segments.

### BRIEF DESCRIPTION OF THE DRAWING FIGURES

The accompanying drawing figures incorporated herein and forming a part of the specification, illustrate several aspects of the disclosed inventions and, together with the textual description, serve to explain certain principles thereof. In the drawing figures:

FIG. 1 is a top perspective view of one embodiment of a single conveyor guiderail adjuster according to one embodiment of the disclosure;

FIG. 2 is a bottom perspective view of the adjuster of FIG. 1;

FIGS. 3, 4, and 5 are top, rear, and bottom views of the FIG. 1 adjuster;

FIG. 6 is a front view of the adjuster of FIG. 1;

FIGS. 7 and 8 are left-and right-side views of the adjuster of FIG. 1;

FIG. 9 is a perspective view of a collapsible guiderail support forming part of the adjuster of FIGS. 1-8;

FIG. 9A is an exploded view illustrating a manner of connecting an arm to one of the supports (shuttles) for pivoting movement;

FIG. 9B is a top view of the assembled configuration of FIG. 9A;

FIG. 9C is a cross-sectional view of the arrangement of FIG. 9A when assembled, taken along line 9C-9C of FIG. 9B;

FIGS. 10 and 11 are top views of the support of FIG. 9 in an extended and retracted condition;

FIG. 12 is a rear view of the support of FIG. 9;

FIG. 13 is a perspective view of a shuttle for connecting to the support for manual operation;

FIG. 14 is an exploded perspective view of the shuttle of FIG. 13;

FIG. 15 is a perspective view of a shuttle for connecting to the support for automated operation;

FIG. 16 is an exploded perspective view of the shuttle of FIG. 15;

FIG. 16A is a partially cross-sectional top view of the shuttle of FIG. 15;

FIG. 17 is a side view illustrating aspects of an actuator for actuating the adjustable guiderail support;

FIG. 18 illustrates a tensioner for a cable forming part of the actuator for the adjustable support;

FIGS. 19, 20, 21, 22 and 23 illustrate alternative forms of actuators;

FIGS. 24, 25, and 26 illustrate a system comprising two opposed guiderails associated with a plurality of adjusters;

FIGS. 24A, 25A, and 26A illustrate another system comprising two opposed guiderails associated with a plurality of adjusters;

FIGS. 27 and 28 illustrate various aspects of an extendable guiderail;

FIGS. 29, 30 and 31 illustrate guides for guiding an endless cable along a curved section of a support rail for the adjusters;

FIGS. 32, 33, and 34 are schematic views illustrating the creation of various zones using the adjustable guiderails according to the disclosure;

FIGS. 35-42 illustrate an embodiment of a manually adjustable guiderail support;

FIGS. 43-54 illustrate a mount for mounting an adjustable guiderail to a conveyor;

FIGS. 55A-55D illustrate an embodiment of a cover for covering mechanical features of a conveyor having an adjustable guiderail;

FIG. 56 is an end view of the cover of FIGS. 55A-55D looking generally along the line 56 of FIG. 55B;

FIG. 57A is a top perspective view of a segment of the cover of FIGS. 55A-55D;

FIG. 57B is a top plan view of the segment of FIG. 57A;

FIG. 57C is a side elevation view of the segment of FIG. 57A;

FIG. 57D is an end view of the segment of FIG. 57A;

FIG. 58A is a perspective view of the cover of FIGS. 55A-55D, with the cover illustrated extending along a straight path;

FIG. 58B is a top view of the cover of FIG. 58A;

FIG. 58C is an enlarged top partial view of the cover shown in FIG. 58B;

FIG. 59A is a perspective view of the cover of FIGS. 55A-55D, with the cover illustrated being articulated in a first direction to extend along an arcuate path;

FIG. 59B is a top view of the cover of FIG. 59A;

FIG. 59C is an enlarged top partial view of the cover of FIG. 59B;

FIG. 60A is a perspective view of the cover of FIGS. 55A-55D, with the cover illustrated being articulated in a second direction, opposite the first direction of FIG. 59A, to extend along an arcuate path;

FIG. 60B is a top view of the cover of FIG. 60A; and

FIG. 60C is an enlarged top partial view of the cover of FIG. 60B.

Reference will now be made in detail to the present preferred embodiments of a customizable cover a conveyor component, examples of which are illustrated in the accompanying drawing figures.

### DETAILED DESCRIPTION

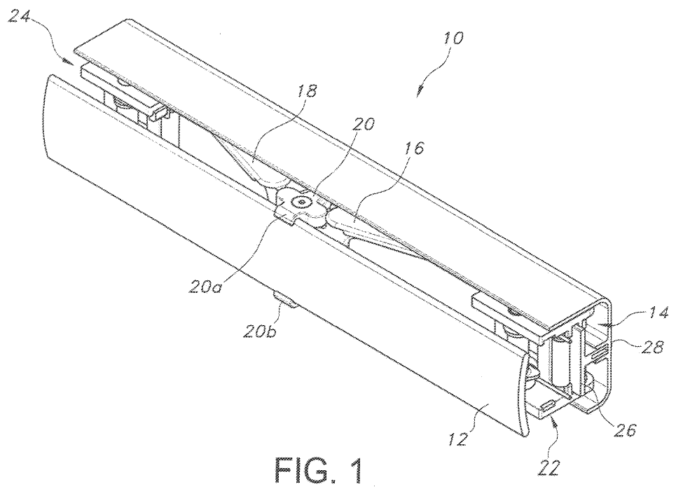

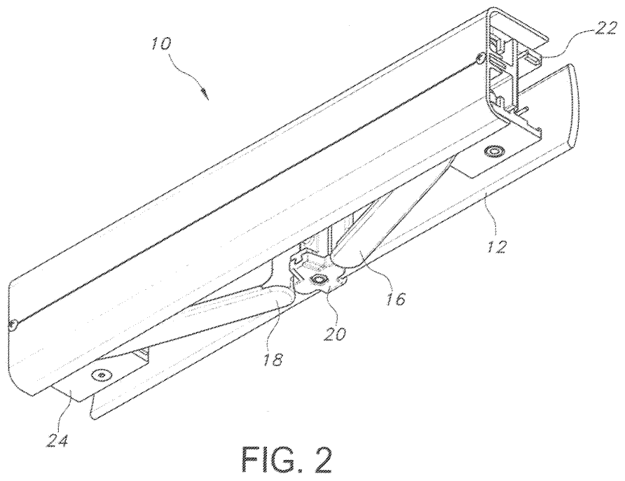

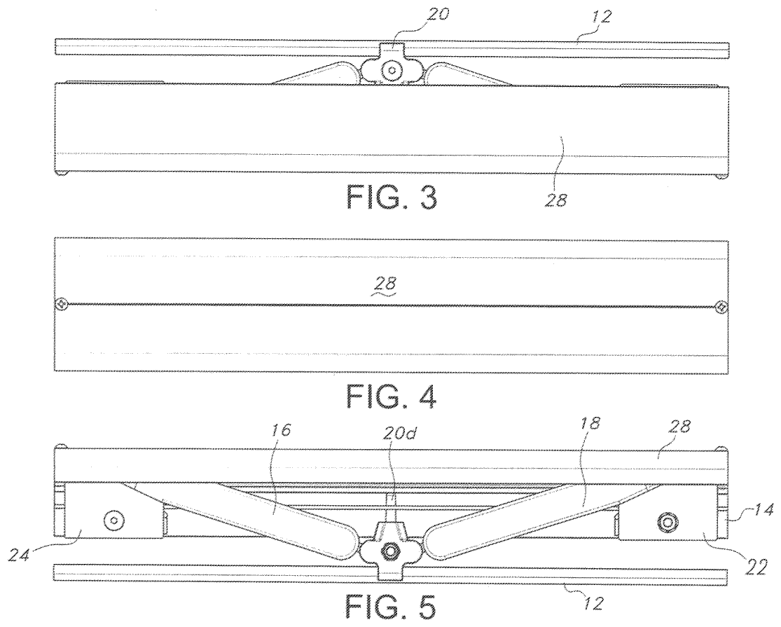

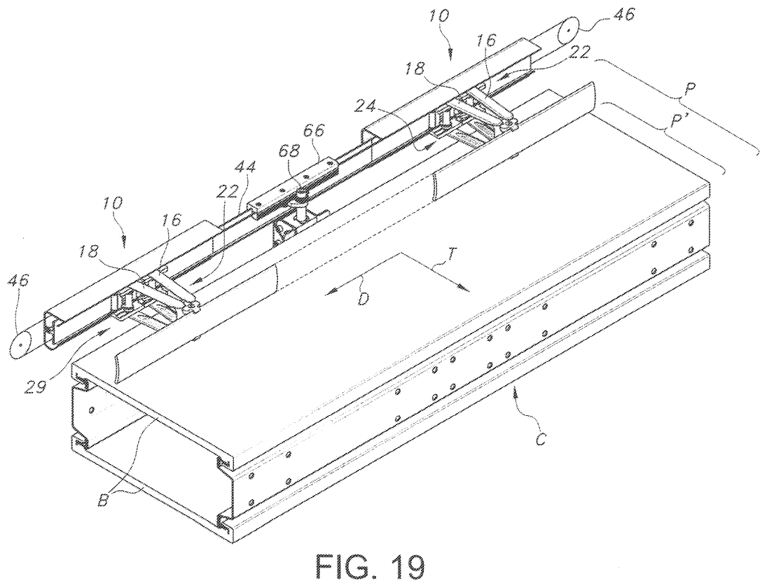

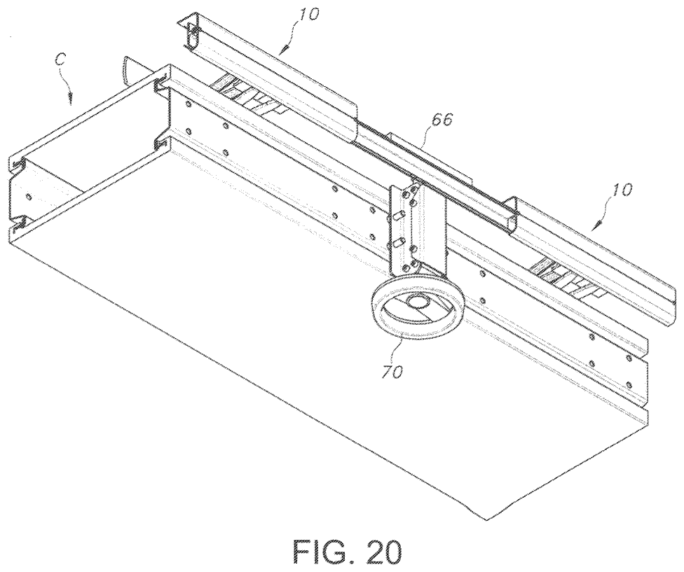

With reference to FIGS. 1-9, one possible embodiment of a guiderail adjuster 10 forming one aspect of the invention is illustrated. As illustrated, the adjuster 10 may be adapted to connect with a guiderail 12 for guiding articles along a conveying path and in a conveying direction D (see, e.g., FIG. 19). The guiderail 12 may be supported by a support 14 forming a part of the adjuster 10, which may be flexible or collapsible (that is, able to be folded into a more compact shape). The adjuster 10 including the support 14 is thus capable of extending or retracting the guiderail 12 to change the relative position of the conveying path, without increasing the overall width of the associated conveyor in a transverse direction as a result of the adjustment.

In one embodiment, the support 14 may comprise links in the form of first and second supports or arms 16, 18 connected to each other. The arms 16, 18 are rigid in the vertical direction, but pivotally connected at their inner end portions, such as by a connector 20. The arms 16, 18 and connector 20 thus create a linkage (which may be in the form of a two bar linkage, but other forms could be used).

At the opposite end, each arm 16, 18 is connected to a structural part designed to reduce or eliminate friction or provide support or bearing. In the illustrated embodiment, this structure takes the form of a movable bolster or shuttle 22, 24 adapted to frictionally (by sliding or rolling) engage an elongated support rail 26, which extends generally parallel with the guiderail 12 in the conveying direction D. Consequently, these connections and the relative movement established allow for flexing or collapsing of the support 14 in a direction transverse to the conveying direction D.

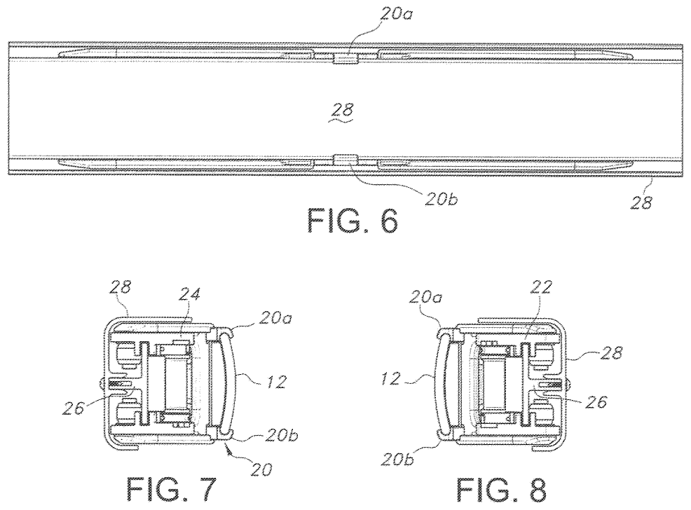

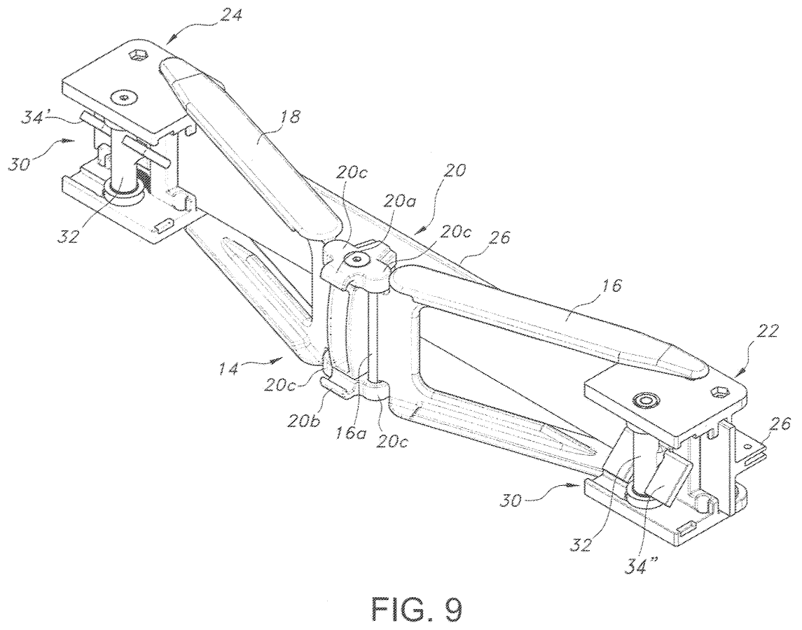

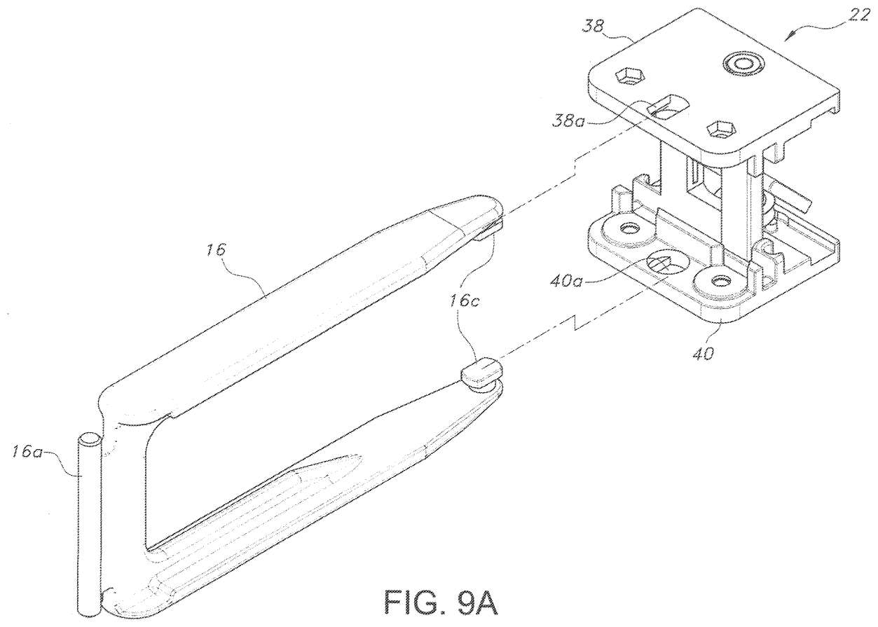

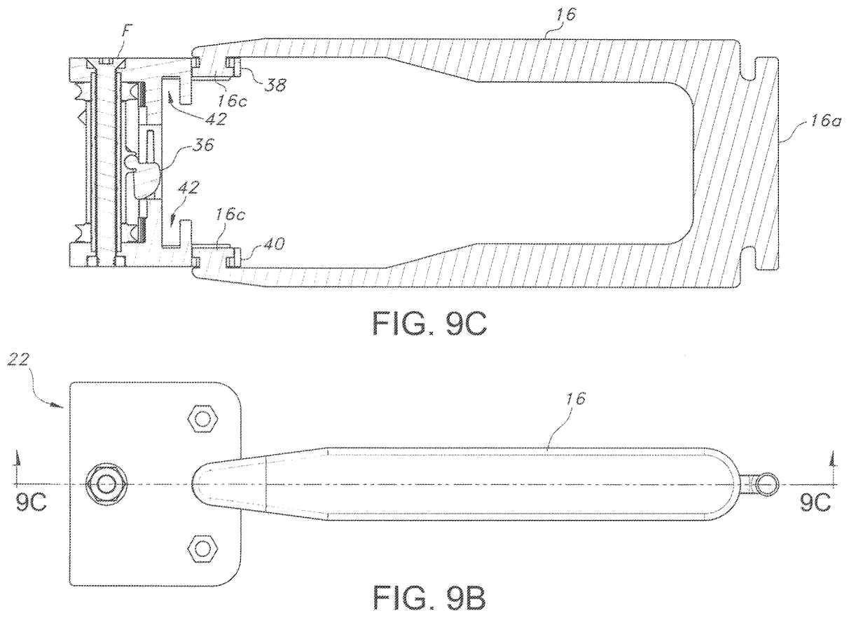

The support 14 is also adapted to connect with the guiderail 12. In the illustrated embodiment, this is achieved by providing the connector 20 with one or more receivers, such as clips 20a, 20b (which as discussed in further detail below may provide engagement such that the guiderail 12 is fixed in position, or may be arranged to allow for relative sliding movement). As can be appreciated from FIG. 6, the arrangement is such that the overall adjuster 10 has a very low vertical profile, with a height only slightly greater than the height of the guiderail 12. As can be seen in FIGS. 1-8, an optional cover 28 may also be provided (removed in FIG. 9), which may engage the support rail 26 and provide a measure of protection for the movable parts of the adjuster 10, but without interfering with their relative movement and operation.

With reference to FIGS. 9 and 12, the nature of the pivoted connection of the arms 16, 18 forming the support 14 for the guiderail in one embodiment is shown. Each arm 16, 18 may be provided with a trunnion 16a, 16b, the ends of which are received and rotatably captured within upper and lower receivers 20c on either side of the connector 20. However, alternative configurations could be used, such as a simple hinge (with a mechanical pin or a living hinge). In any case, movement of the shuttles 22, 24 along the support rail 26 towards each other causes the connector 20, and hence, the associated guiderail (not shown) to move along an adjacent conveying surface in a direction transverse to the conveying direction. The movement is considered a flexible one, in that the pivoting of the arms 16, 18 relative to the connection allows flexing of the flexible joint thus formed. Likewise, movement of the shuttles 22, 24 in the opposite direction (farther away from each other) causes the arms 16, 18 to flex relative to each other (and connector 20) and thereby retract the guiderail 12.

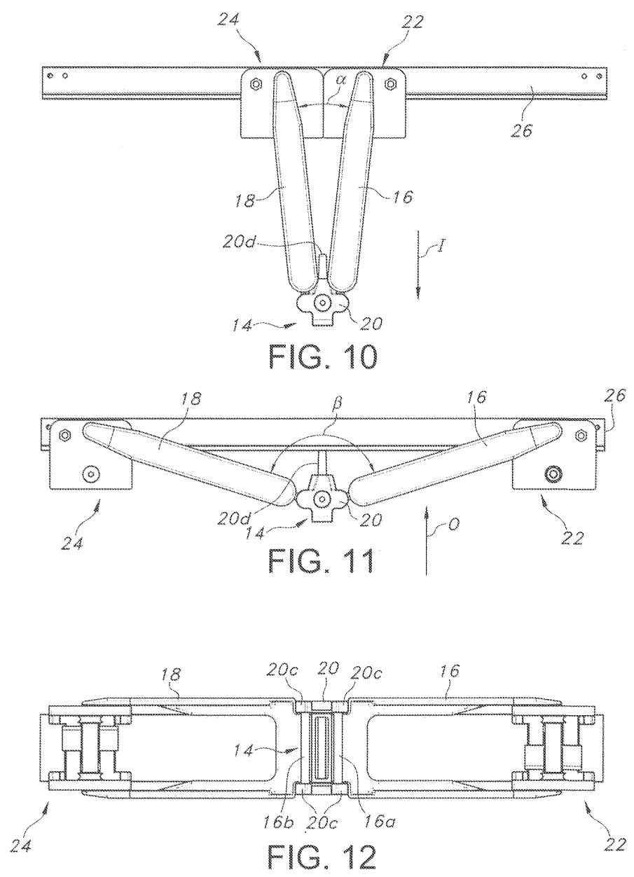

Allowing the arms 16, 18 forming the linkage to reach a “bottomed out” (β=180 degrees or more) and potentially locked position may be undesirable (especially when the actuation of the adjusters 10 is automated, as compared to manual). Thus, as can be appreciated from FIGS. 10 and 11, this condition may be avoided by providing the side of the connector 20 opposite the guiderail 12 with a protrusion or extension 20d projecting transverse to the conveying direction, which thus serves to define the maximum flexing of the joint formed between the arms 16, 18. This protrusion or extension 20d of the connector 20 may be sized and positioned to engage the support rail 26 in the fully collapsed position of the linkage, and thus prevent it from bottoming out and becoming locked in position. Of course, the protrusion could also be provided on one or both of the arms 16, 18, or even on the support rail 26, to achieve a similar result.

As can be appreciated with reference to FIGS. 10, 11, and 12, by way of being selectively extended or retracted, the support 14 creates an enhanced level of adjustability for an associated guiderail 12. The adjustments may be achieved in an easy and efficient manner, and without remarkably increasing the footprint of the overall conveyor system. Specifically, extending or retracting the support 14 allows the guiderail 12 pivotally attached thereto by virtue of connector 20 to be configured to provide a variable width conveying path for a number of differently sized articles to be conveyed. For example, when a smaller sized article is desired to be conveyed, the guiderail 12 need only be moved in an inward or inboard direction I transverse to the conveying direction D, thereby causing it to collapse in this direction (and thus causing the flexible joint to assume an acute angle α, such as for example as little as 5 degrees in the illustrated example, and possibly lower in the event the arms 16, 18 may be arranged parallel to each other)). In other words, the arms 16, 18 move from a position where the relative angle between them is greater to one in which it is reduced or smaller. This narrows the conveying path, and allows for a readily customizable arrangement for guiding differently sized articles.

Likewise, if it is desired to convey a larger sized article/object or otherwise extend the width of the conveying path relative to the underlying conveyor, the guiderail 12 need only be moved in an outward or outboard direction O transverse to the conveying direction D (and thereby flexing the joint so as to create a large, obtuse angle β between the arms 16, 18, which may be up to but not including 180 degrees, and as shown is limited by the presence of the extension or protrusion 20d to prevent a lock out condition). In other words, the arms 16, 18 move from a position where the relative angle between them is smaller to one in which it is greater. In all cases, it can be appreciated that no rod or like structure projecting outwardly from the support rail 26, and thus the overall width of the arrangement does not change as a result of the extension or retraction. The resulting conveyor system may thus have a smaller footprint than would otherwise be the case if transversely extending rods and corresponding mounts were utilized.

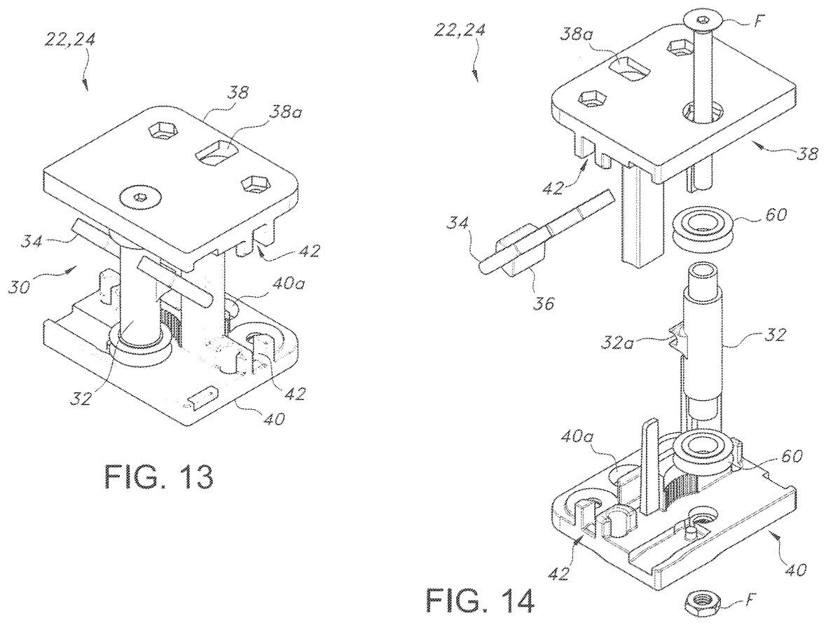

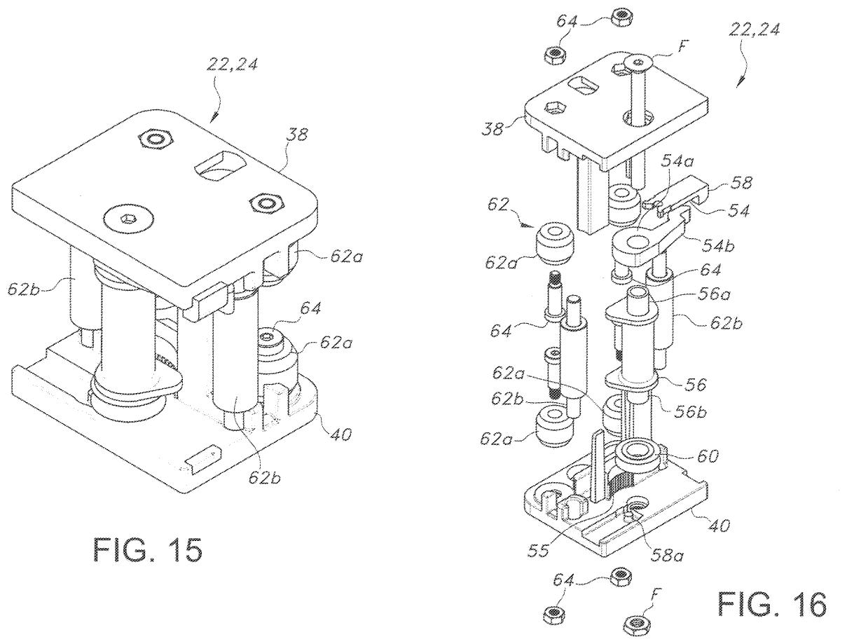

The adjustment of the support 14 may be manually or automatically done. In the manual version, and with reference to FIGS. 13 and 14, each shuttle 22, 24 may be provided with a retainer 30 for use in selectively engaging the support rail 26 and thereby holding the shuttle in the desired position. In the illustrated embodiment, the retainer 30 comprises a post 32 supporting an actuator in the form of a pivotally mounted lever 34, such as by way of snap-fit engagement with a clip 32a. The inside of the lever 34 includes a wedge 36, which is sized and positioned for not engaging the rail 26 in one position, but frictionally engaging it in a different position (note positions 34′ (free) and 34″ (retained) in FIG. 9). Opposed plates 38, 40 may be retained by a fastener F to hold the post 32 in position, and each plate 38, 40 may include a guide 42 for slidably receiving a portion of the support rail 26. The plates 38, 40 may also include apertures 38a, 40a for receiving a corresponding fastener (such as a keyway plug 16c; see FIGS. 9A, 9B, and 9C) depending from a proximal end of each arm 16, 18 for pivotally connecting the ends of the arms 16, 18 with the shuttles 22, 24.

As can be appreciated, by disengaging the retainer 30 using lever 34, the associated shuttle 24 is free to move to and fro, such as by sliding, along the support rail 26, and thereby extend or retract the support 14 and, hence, the associated guiderail 12. When a position is reached corresponding to the desired extension or retraction of the guiderail 12, the retainer 30 may be reactivated to establish fixed engagement with the support rail 26. As can be appreciated, it is only necessary to move one of the shuttles 22, 24 to achieve the desired extension or retraction of the guiderail 12 in view of the collapsible nature of the support 14 created by the pivotably connected arms 16, 18.

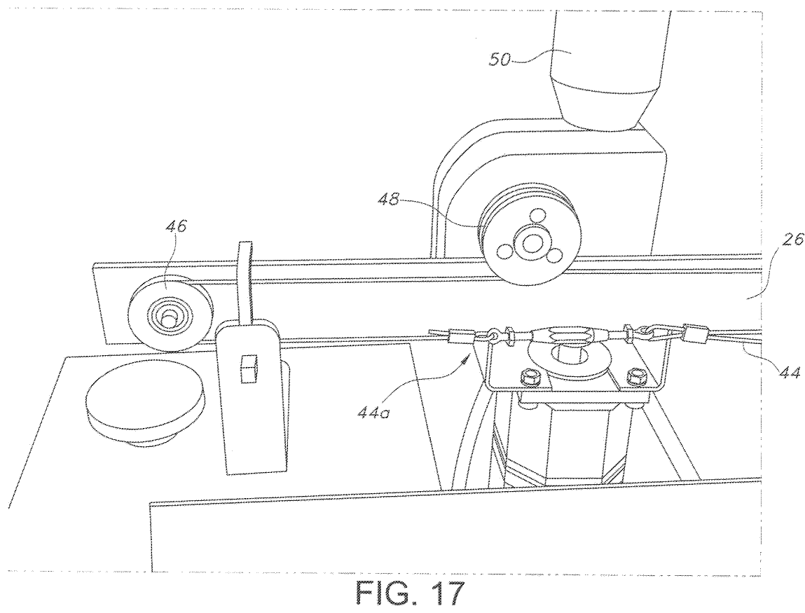

The shuttles 22, 24 may also be readily adapted to work in an automated environment. Specifically, at least one, and potentially each shuttle 22, 24 may be adapted to engage an actuator for causing movement to and fro along the support rail 26, depending on the degree of actuation, and thus extending or retracting the arms 16, 18. As shown in FIG. 17, the actuator may comprise a connector for connecting with the shuttles 22, 24, such as a flexible cable 44. The cable 44 may extend over pulleys 46 at each end (only one shown in FIG. 17 mounted to one end of the support rail 26, but the arrangement would essentially be the same as shown at the opposite end of the support rail 26; see, e.g., FIG. 19). The arrangement thus forms an endless loop (which may be associated with plural adjusters 10, as outlined further in the following description).

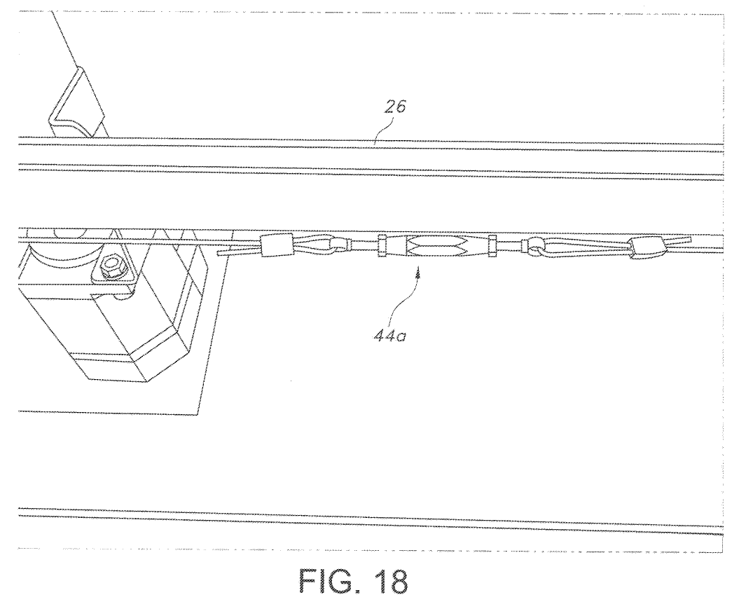

To cause the cable 44 to traverse the endless path, it may be entrained around a driver, such as capstan 48, which may be associated with a motor 50 (e.g., a servomotor) also forming part of the actuator in this embodiment. As shown in FIG. 18, the cable 44 may also be provided with a tensioner, such as a turnbuckle 44a, to allow for the tension to be adjusted as necessary or desired.

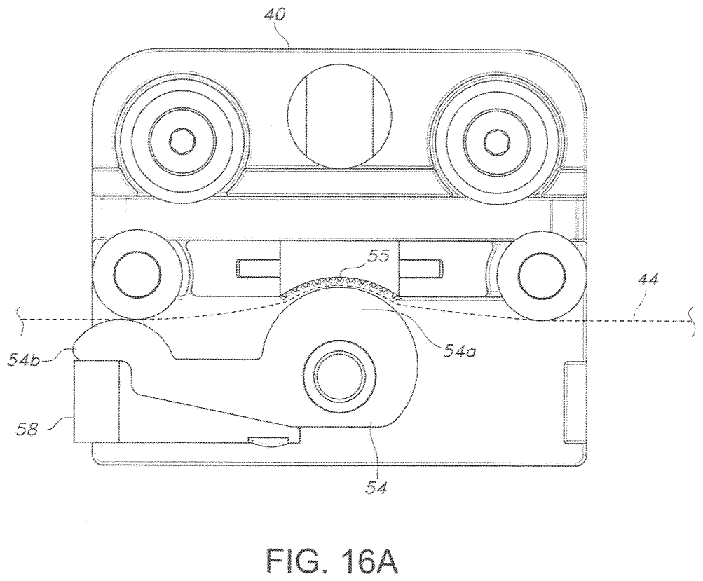

In this example, and with reference to FIG. 16, each plate 38, 40 may be provided with a retainer 52 for selectively engaging the cable 44. The retainer 52 may comprise a clamp in the form of a pivotable cam 54 (only upper one shown in FIG. 16), but could take other forms as well (e.g., a bolt with a flange for capturing a portion of the cable 44 against a corresponding surface of the shuttle). The cam 54 may be journaled on a reduced diameter end 56a of a post 56, which may be held in place by a fastener F.

In the illustrated example, and with reference to FIGS. 16 and 16A, the cam 54 includes an enlarged, rounded inner face 54a for engaging and pressing the cable into engagement with a frictionally enhanced portion 55 of the plate 38, 40 (which may be identical, but inverted; in other words, plate 38 is identical in form to plate 40 in FIG. 16, so it can be understood that the upper plate includes frictionally enhanced portion 55), and a free end 54b adapted for tactile engagement for movement between the hold and release position. A lock, such as a removable locking tab 58 with flexible legs for engaging a projection 58a in a snap fit engagement, may also be provided for engaging and fixing the cam 54 in the locked or closed condition, thus engaging the cable (shown in phantom line in FIG. 16A). A roller or pulley 60 may be rotatably journaled at the opposite, reduced diameter end 56b of post 56 (upper when the cam 54 is at the lower plate 38; lower when the cam 54 is at the upper plate 38, as shown in FIG. 16).

As can be appreciated, the cable 44 has a forward run and a return run in view of the endless loop established. By connecting one shuttle 22 to the upper run using the clamp (cam 54) located as shown in FIG. 16, and connecting the other shuttle 24 to the return run using a clamp (cam 54 on plate 40, as per FIG. 16A) at a corresponding location, actuation using a single actuator thus causes the shuttles 22, 24 to move toward or away from each other, thereby flexing the joint of the support 14 created by arms 16, 18 and extending or retracting the guiderail 12. The alternate run of the cable 44 that is not fixed to the shuttle 22, 24 simply engages the roller/pulley 60, and thus does not impede the relative movement.

With continued reference to FIG. 16, each shuttle 22, 24 may also be provided with rollers 62 to create low-friction engagement with the support rail 26. The rollers 62 may comprise individual rollers 62a connected to the plates 38, 40 by fasteners 64 and arranged for engaging an outer face of the support rail 26, as well as rollers 62b journaled in the plates 38, 40 for engaging the inside face of the support rail 26. As can be appreciated, the spaced rollers 62a allow for a portion of the rail 26 to pass for engaging and supporting the cover 28.

Alternative forms of actuation are possible, which advantageously may use a single actuator for activating plural adjusters 10 for adjusting the width of the conveying path. For example, as shown in FIG. 19, the connector, such as cable 44, may be associated with a rack 66, which is arranged for engaging a rotatable pinion 68. In view of the endless nature of the cable 44, and the corresponding connections with the shuttles 22, 24 as described above, actuation of the pinion 68 in one direction causes the simultaneous actuation of plural adjusters 10. This advances the guiderail 12 (shown as two disconnected portions with phantom portion for purposes of illustration) in the transverse direction T of the conveyor C (which as indicated has a conveying path P formed by a conveying surface (chain or belt B) in the conveying direction D, and note reduced width path P′ as a result of the advance of the guiderail 12 in the transverse direction). Specifically, rotating the pinion in a clockwise direction moves the rack to the right in FIG. 19, and in view of the connection of the forward run of the cable 44 with shuttles 22 of each guiderail adjuster 10, and the return run with shuttles 24, causes the advancement illustrated. Reversing the direction of rotation of pinion 68 causes the opposite movement to occur.

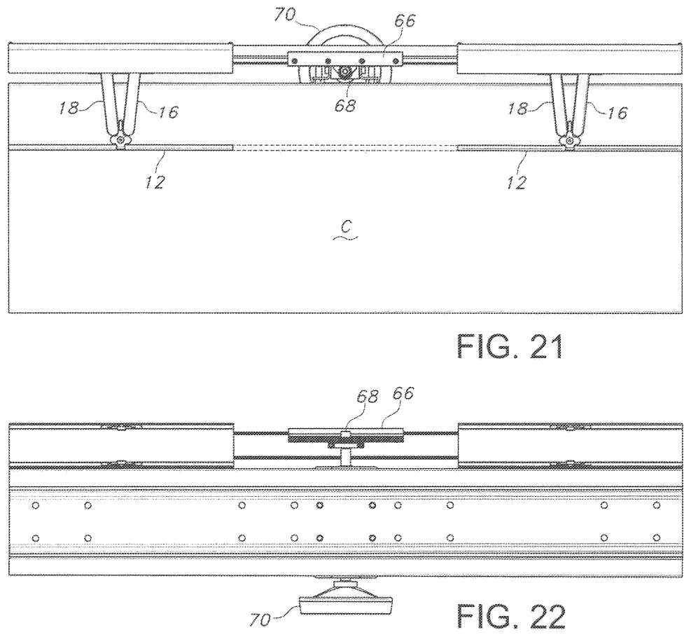

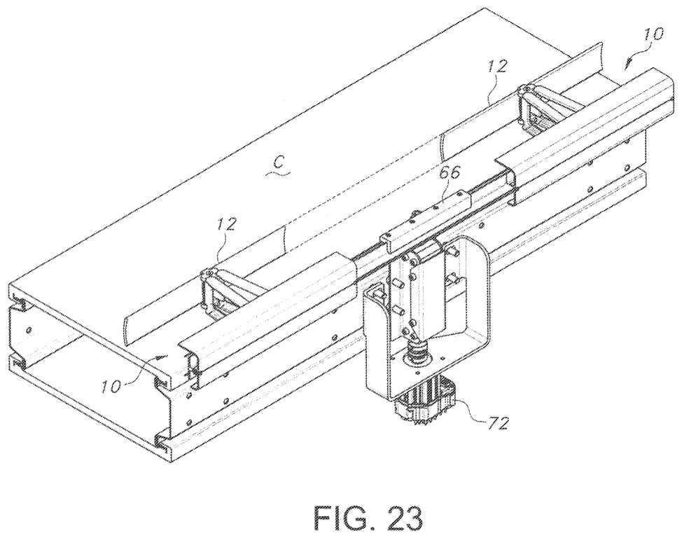

The actuation of the adjusters 10 associated with the conveyor C may again be manual or automated. Thus, as shown in FIGS. 20-22, a hand wheel 70 may be connected to the associated conveyor C and rotated to cause the actuation of one or more of the adjusters 10 (basically, as many as are connected to a single connector or cable 44, which could be any number (2, 5, 10, 20 or more), depending on the strength of the actuator arrangement used. FIG. 23 illustrates the use of a motor 72 (e.g., servomotor) for automated operation.

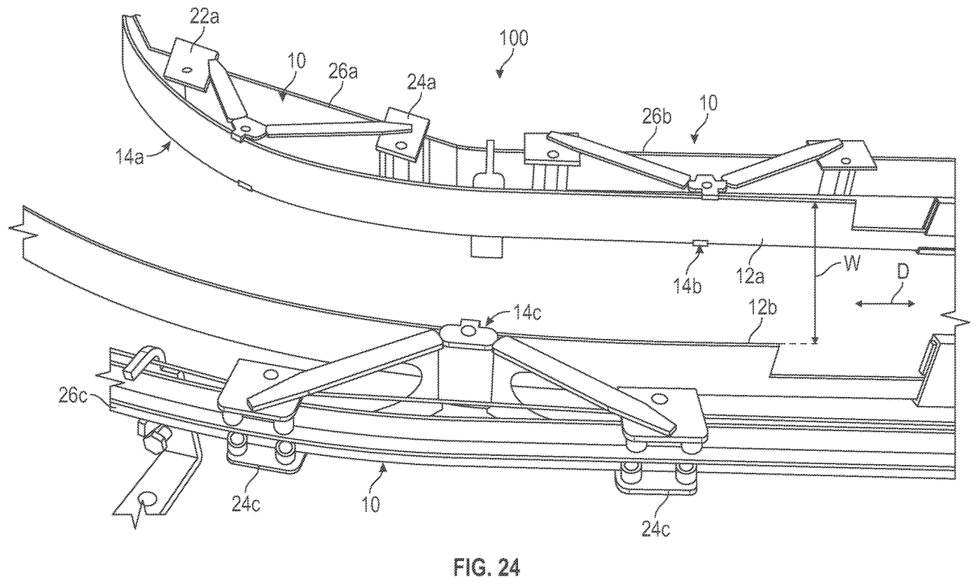

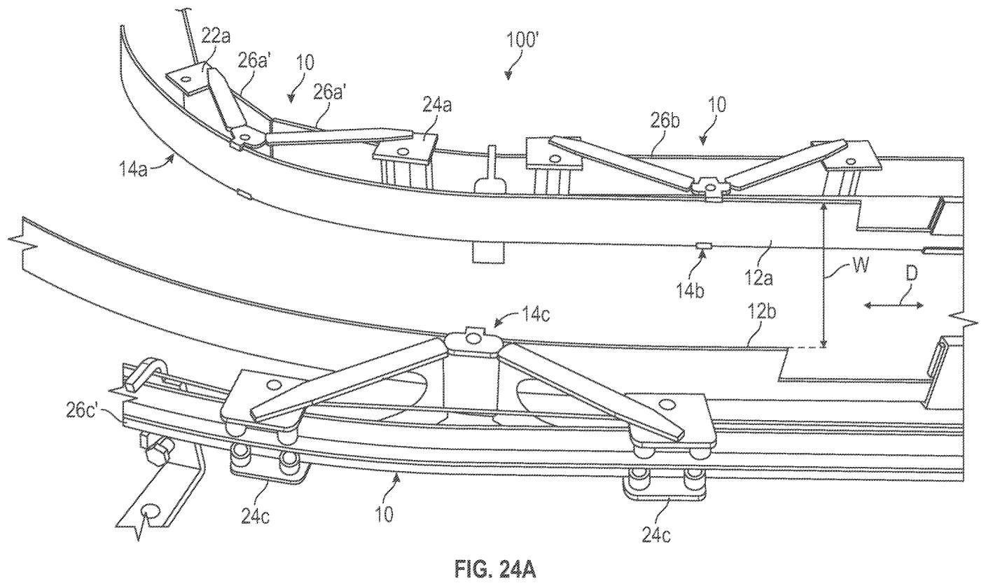

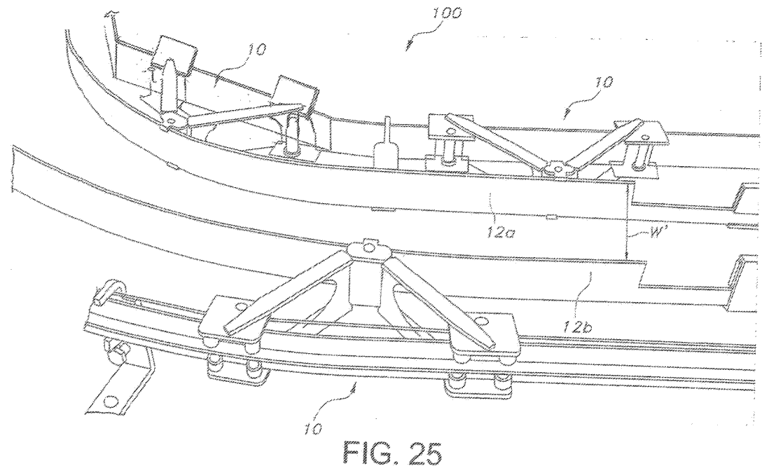

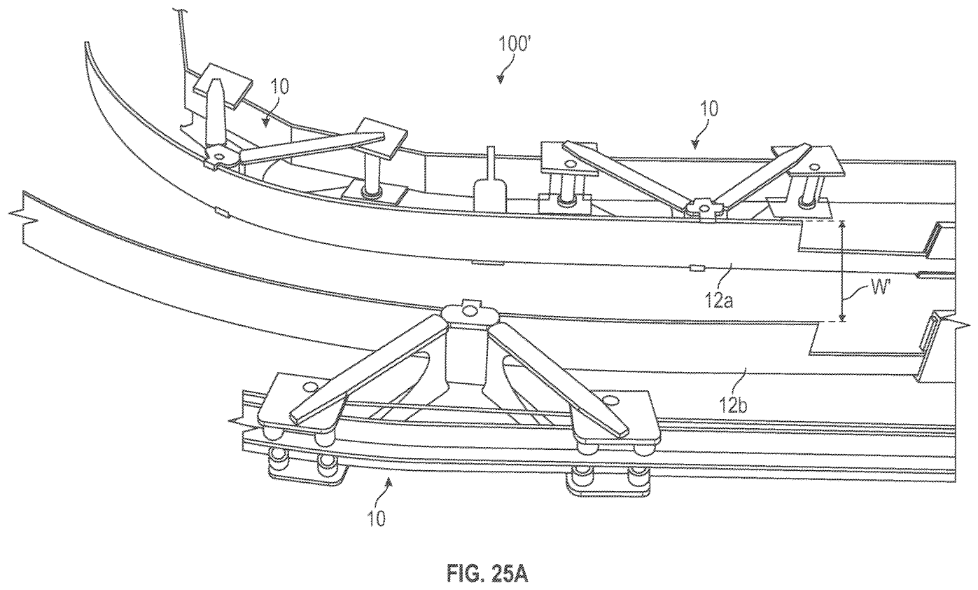

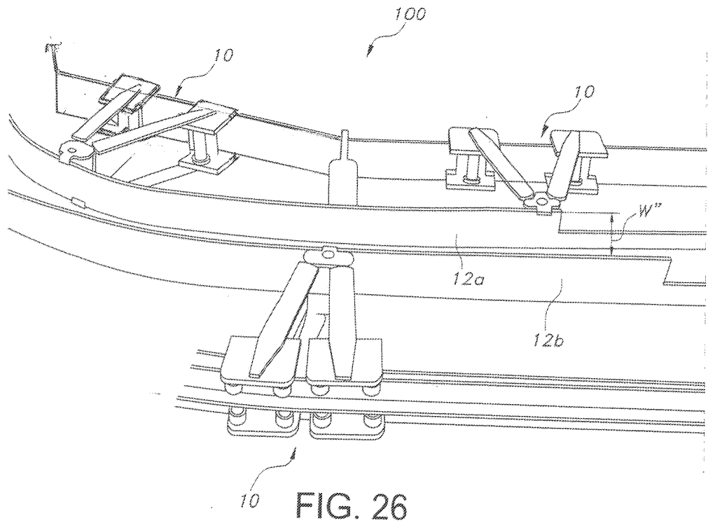

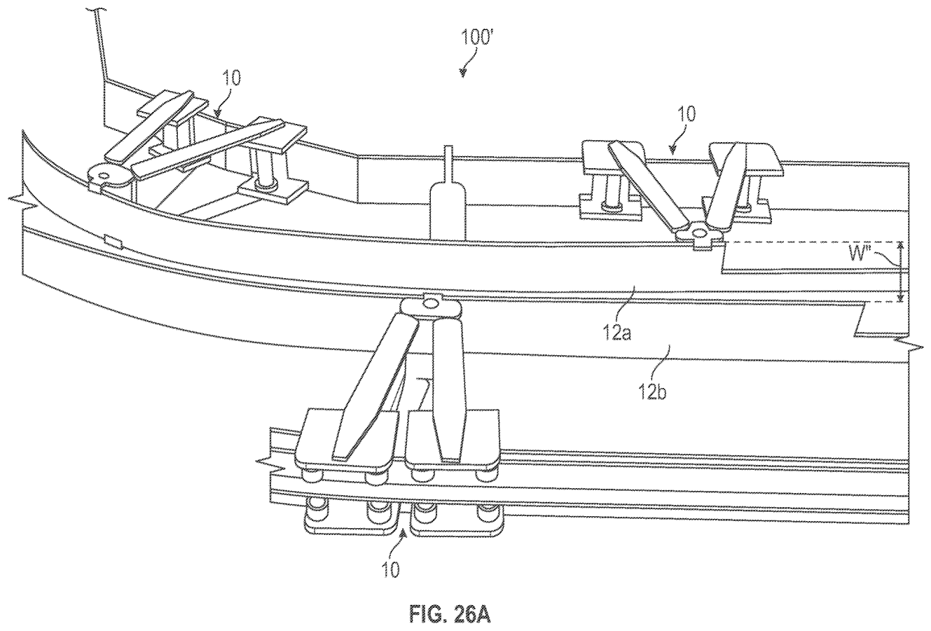

FIGS. 24-26 illustrate an overview of a possible arrangement of the adjustable guiderail support system 100 incorporating a plurality of adjusters 10 for use in connection with a conveyor having a conveying path with non-straight, arcuate paths (not shown). Opposed inner and outer guiderails 12a, 12b are shown for guiding articles (not shown) along the conveying path. The adjustable inner guiderail supports 14a, 14b are supporting the inner guiderail 12a and the adjustable outer guiderail support 14c is supporting outer guiderail 12b. Thus, if it is desired adjust the conveying path width W to accommodate differently sized articles (or groups thereof), inner guiderail 12a (along with inner guiderail supports 14a, 14b) and outer guiderail 12b (along with outer guiderail support 14c and any others present) may be moved. The movement may again be manual or automatic using a single actuator (including cable 44) transverse the conveying direction D along each support rail 26 (with an associated motor, the operation of which may be coordinated by a single controller) in order to widen or narrow the conveying path width W (note smaller width W′ in FIG. 25, and even smaller width W″ in FIG. 26, which may correspond to a single row of articles being conveyed, such as bottles or cans). In such situations, it may be desirable to have the receivers (e.g., clips 20a, 20b) firmly engage the guiderail 12a, 12b at every other adjuster 10, but slidably engage at others, to allow for the desired extension and retraction.

In the non-limiting embodiment illustrated in FIGS. 24-26, the inner guiderail support 14a is provided to move along an arcuate section, also referred to as non-straight section, arcuate bend, arcuate path, or rounded corner, of the inner and outer guiderails 12a, 12b, while the inner guiderail support 14b is provided along a linearly straight section of the inner and outer guiderails 12a, 12b. The inner guiderail support 14a is supported by a first inner support rail 26a, while the inner guiderail support 14b is supported by a second inner support rail 26b. The outer guiderail support 14c is supported by an outer support rail 26c. To facilitate smooth, uniform adjustment of the inner and outer guiderails 12a, 12b extending along the arcuate section of the conveyor, the linear distance of the respective first inner support rail 26a extending along the arcuate section can be provided being the same or substantially the same as the linear distance of the corresponding, opposite outer support rail 26c. As such, the shuttles 22a, 24a traversing along the first inner support rail 26a and shuttles 22c, 24c traversing along the outer guiderail support rail 26c can be provided to move the same or substantially the same distance with one another during adjustment of the inner guiderail support 14a and the outer guiderail support 14c. Accordingly, any mechanisms used to facilitate adjustment of the inner and outer guiderails 12a, 12b, whether mechanical or automated, such as cable(s) 44 used to drive the shuttles 22a, 24a, 22c, 24c, can be provided to move the same or substantially the same distance, thereby avoiding a build-up of any slack in the corresponding mechanisms, and thus, causing a uniform extension/contraction stroke of the shuttles, regardless of their respective locations. In FIGS. 24-26, the shuttles 22a, 24a of the inner guiderail support 14a are configured to move along a linearly straight path in coaxial relation with one another during adjustment of thereof. The inner guiderail support 14a can be provided as a single guiderail support to extend along the entirety of the arcuate section, or a plurality (any numbered needed) of inner guiderail supports can be provided with shuttles thereof being configured to move along a straight or substantially straight linear path with one another. It is to be recognized that the aforementioned description of the first inner support rail 26a extending along the arcuate section applies equally to the outer support rail 26c, such that the outer support rail 26c can be made of one or more linearly straight segments. Further yet, the first inner support rail 26a can be formed of an arcuate section, while the outer support rail 26c forming the arcuate section can be formed of one or more linearly straight sections, such that the travel distance along the arcuate section outer support rail 26c is the same or substantially same as the travel distance along the first inner support rail 26a. The inner and outer guiderail supports 14a, 14c can be provided as single guiderail supports to extend along the entirety of the arcuate section, or a plurality (any numbered needed) of inner and outer guiderail supports can be provided with shuttles thereof being configured to move along a straight or substantially straight linear path with one another, as desired.

In the non-limiting embodiment illustrated in FIGS. 24A-26A, another adjustable guiderail support system 100′ incorporating a plurality of adjusters 10 is illustrated, wherein the inner guiderail support 14a is provided to move along an arcuate section, also referred to as arcuate bend, arcuate path or rounded corner, of the inner and outer guiderails 12a, 12b, while the inner guiderail support 14b is provided along a linearly straight section of the inner and outer guiderails 12a, 12b. The inner guiderail support 14a is supported by a first inner support rail 26a′, while the inner guiderail support 14b is supported by a second inner support rail 26b′. The outer guiderail support 14c is supported by an outer guiderail support rail 26c′. To facilitate smooth, uniform adjustment of the inner and outer guiderails 12a, 12b extending along the arcuate section of the conveyor, the linear distance of the respective first inner support rail 26a′ extending along the arcuate section can be provided being the same or substantially the same as the linear distance of the corresponding, opposite outer support rail 26c′. As such, the shuttles 22a, 24a traversing along the first inner support rail 26a′ and shuttles 22c, 24c traversing along the outer support rail 26c′ can be provided to move the same or substantially the same distance with one another during adjustment of the inner guiderail support 14a and the outer guiderail support 14c. Accordingly, any drive mechanism(s) used to facilitate adjustment of the inner and outer guiderails 12a, 12b, whether mechanical or automated, such as cable(s) 44, by way of example and without limitation, can be provided to move the same or substantially the same distance along the direction of travel D, thereby avoiding a build-up of any slack in the corresponding drive mechanism(s). In FIGS. 24A-26A, the shuttles 22a, 24a of the inner guiderail support 14a are configured to move along separate linearly straight paths of the first inner support rail 26a′ arranged in inclined, oblique relation with one another. Accordingly, the shuttle 22a travels along a first straight linear path, while the shuttle 24a travels along a second straight linear path in inclined, oblique relation to the first linearly straight path. It is to be recognized that the aforementioned description of the first inner support rail 26a′ extending along the arcuate section applies equally to the outer support rail 26c′, such that the outer support rail 26c′ can be made of one or more linearly straight segments. Further yet, the first inner support rail 26a′ can be formed of an entirely arcuate section, while the outer support rail 26c′ forming the arcuate section can be formed of one or more linearly straight sections, such that the travel distance along the arcuate section outer support rail 26c′ is the same or substantially same as the travel distance along the first inner support rail 26a′. The inner and outer guiderail supports 14a, 14c can be provided as single guiderail supports to extend along the entirety of the arcuate section, or a plurality (any numbered needed) of inner and outer guiderail supports can be provided with shuttles thereof being configured to move along a straight or substantially straight linear path with one another, as desired.

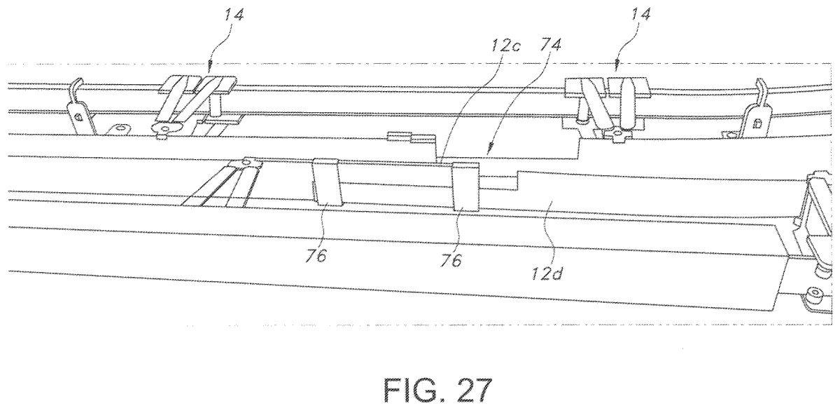

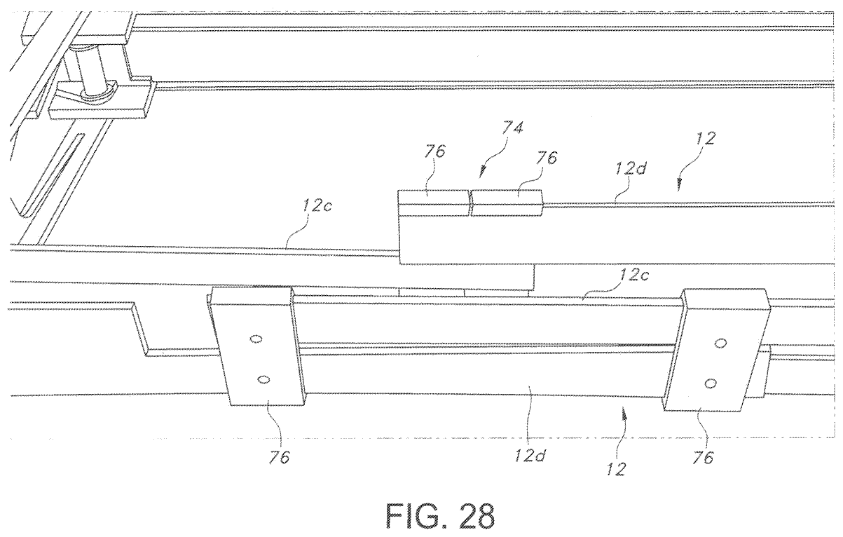

FIGS. 27-28 illustrate that the guiderail 12 may comprise an extendable joint 74 comprised of portions, such as legs 12c, 12d, having a reduced vertical dimension (basically each equal to one half of the overall guiderail height). These legs 12c, 12d may overlie each other or overlap in a vertical direction, and are slidably received in receivers 76, which may take the form of C-shaped clamps that allow for relative movement of the legs (toward a common center during retraction of the guiderail 12 and away from it during extension). The receivers 76 thus retain the legs 12c, 12d together, yet capable of relative movement in the conveying direction during extension and retraction of the associated guiderail portions. This allows for the guiderail 12 to provide the desired extension and retraction, such as via supports 14, to accommodate a particular article being conveyed or form a particular conveying path. Hence, one or both of the legs 12c, 12d may be curved, but use of the supports 14 in connection with straight portions that are connected by the extendable joints is also possible. It can also be appreciated from FIG. 28 that the extendable joints 74 allow for opposing guiderails 12 to extend or retract different amounts, which may occur when one is associated with an inside curve and the other with an outer curve.

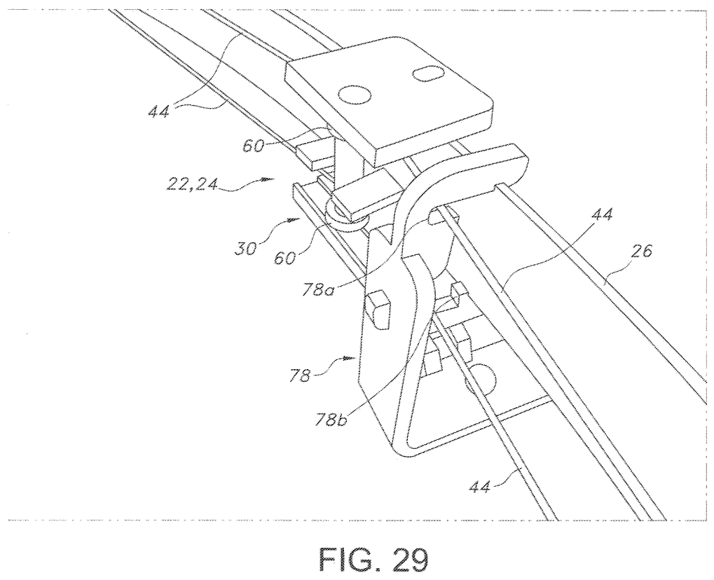

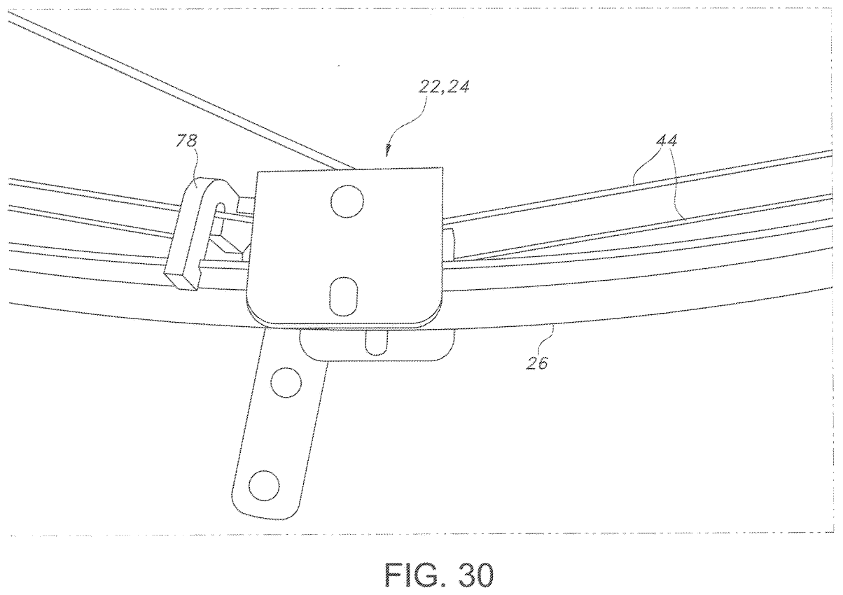

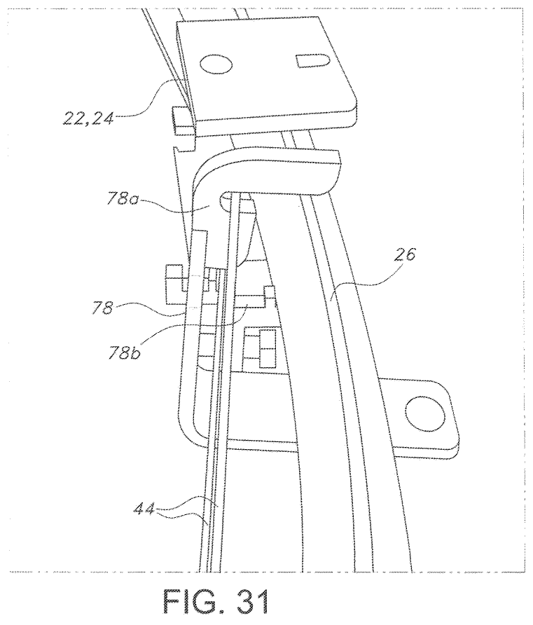

Depending on the size or shape of the underlying conveyor C, it may also be desirable to provide a guide intermediate the adjusters 10 for guiding the connector, such as cable 44. As shown in FIGS. 29-31, this may be achieved using the manual shuttle 22 or 24 of FIGS. 13 and 14, which may be equipped with pulleys 60 for engaging the upper and lower runs of the cable 44. The shuttles 22, 24 may be selectively positioned using the associated retainers 30. Stationary brackets 78 may also be provided with upper and lower guides 78a, 78b for guiding the respective runs of the cable 44.

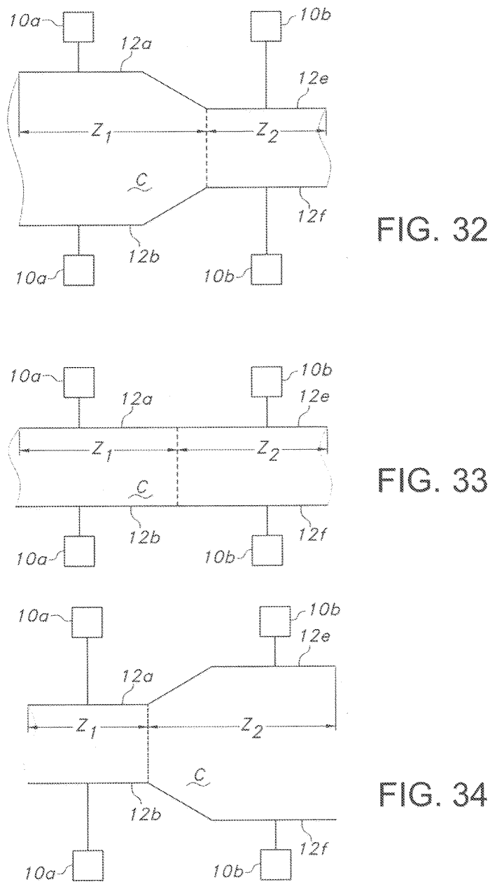

FIGS. 32-34 schematically illustrate a possible application of the adjusters 10 to create zones of different widths in a single conveyor or conveyor system (e.g., comprised of multiple conveyors). As shown in FIG. 32, a first series of adjusters 10a associated with an underlying conveyor C may be used to provide an upstream portion of the conveyor with guiderails 12a, 12b spaced farther apart, thus forming a first zone Z1, and a second series of adjusters 10b may be used to place downstream guiderails 12e, 12f spaced closer together, thus forming a second zone Z2. The adjusters 10a, 10b may be manually adjusted, or associated with different actuators (e.g., a cable system, as described above). Later in time, as indicated in FIG. 33, the adjusters 10a, 10b may be altered to make the zones Z1, Z2 the same width, or for zone Z2 to be wider than zone Z1, as indicated in FIG. 34. As can be appreciated, the material of the guiderails 12a-12b may be flexible or include flexible interconnections (including the joints 74 described above) to allow for the relative movement, which is exaggerated in the schematic figures for purposes of illustration).

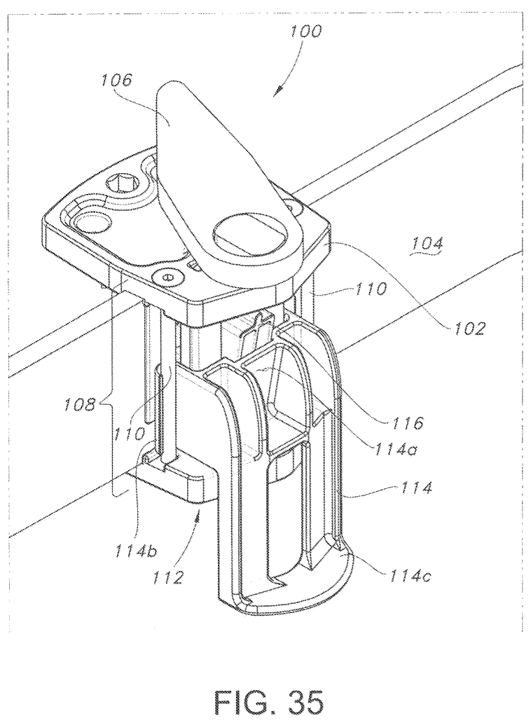

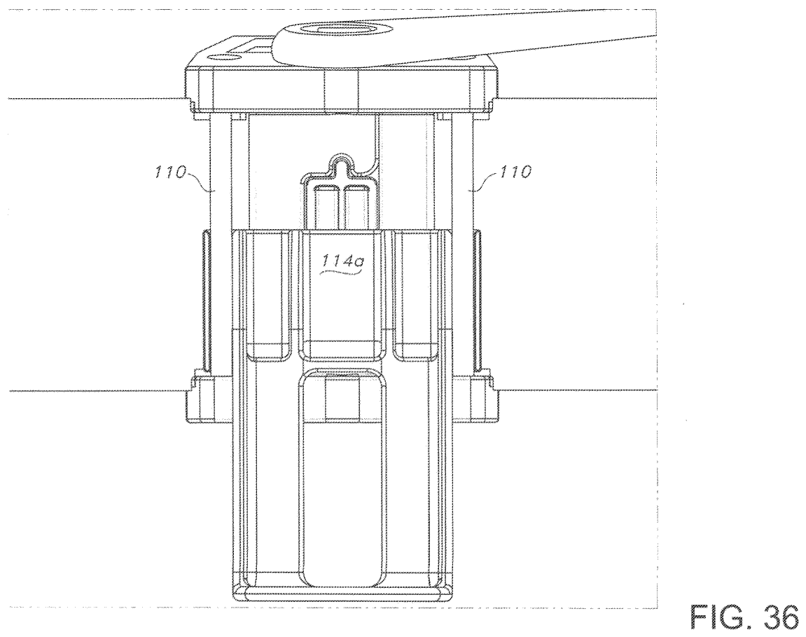

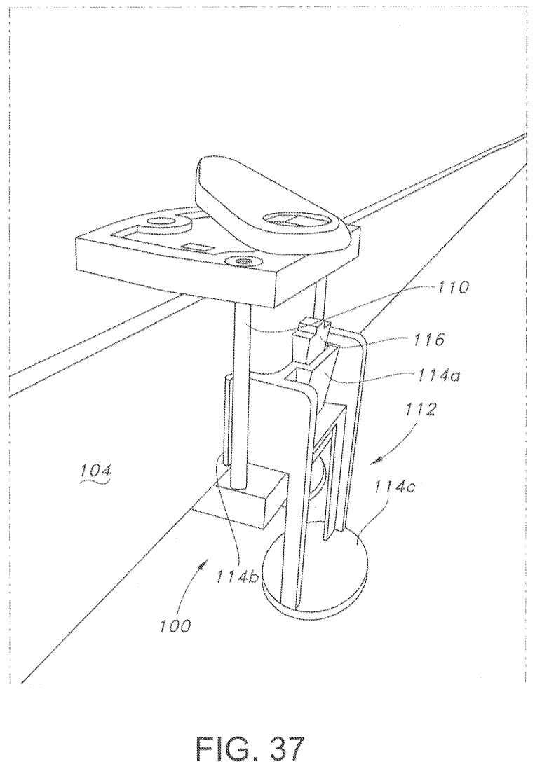

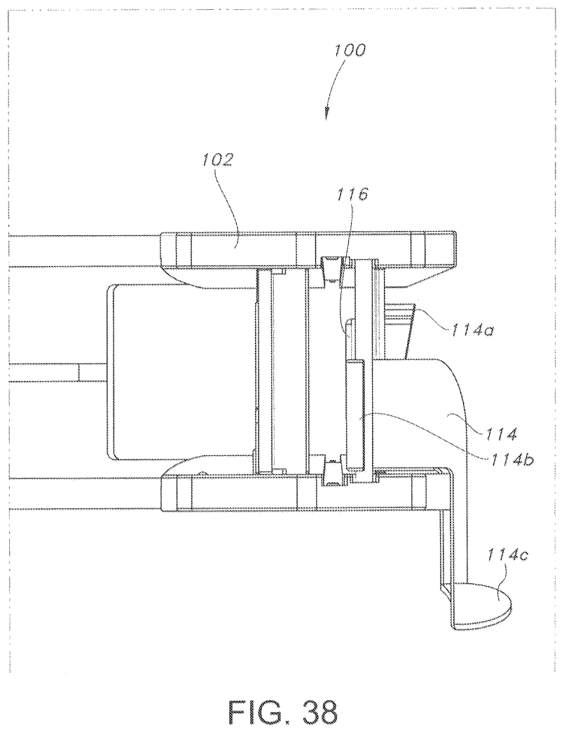

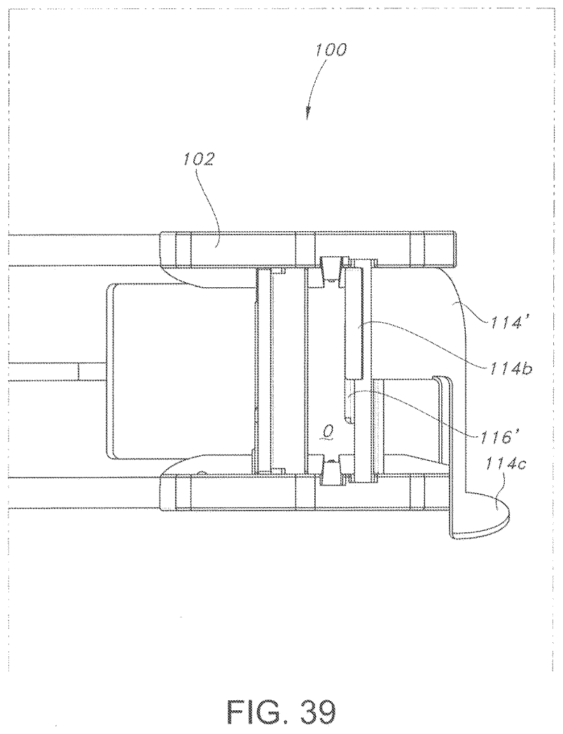

An alternate embodiment of an adjuster including one or more movable supports 100 adapted for being manually adjusted is described with reference to FIGS. 35-42. From FIGS. 34, 35, and 36, it can be understood that each movable support 100 comprises a connector in the form of a shuttle 102 for engaging a stationary support rail 104, and which is connected to a guiderail support arm 106. The shuttle 102 includes a body 108 including a pair of retainers 110 for supporting a clamp 112. The clamp 112 comprises an actuator in the form of a lever 114 adapted for moving along the retainers 110, such as in a vertical direction. Movement of the lever 114 forces a movable retainer, such as a wedge 116 into engagement with the corresponding (outer) surface of the support rail 104 (compare position of lever 114 and wedge 116 in FIG. 38 with raised position of lever 114′ and wedge 116′ in FIG. 39 for engaging the support rail (not shown) that would be present in opening Q).

The lever 114 may include a receiver 114a for receiving the wedge 116 and urging it into engagement with the support rail 104 as the lever is moved, such as in a vertical direction. The lever 114 may further channels 114b for receiving the retainers 110, which may be frictionally enhanced (such as by including threading, as shown), to create a suitable retention force and hold the lever 114 in the actuated condition as a result of the outwardly directed force created by wedge 116, yet be easily releasable using finger action (note handle 114c for this purpose; that is, moving the lever 114 upwardly to force the wedge 116 into engagement with the support rail).

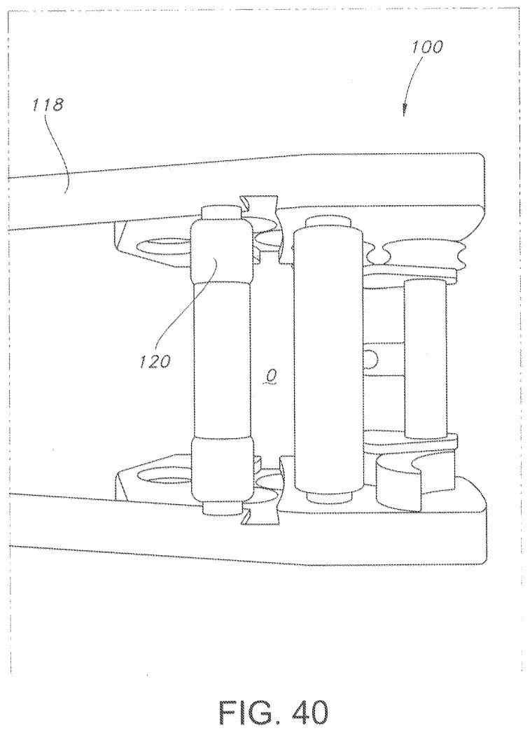

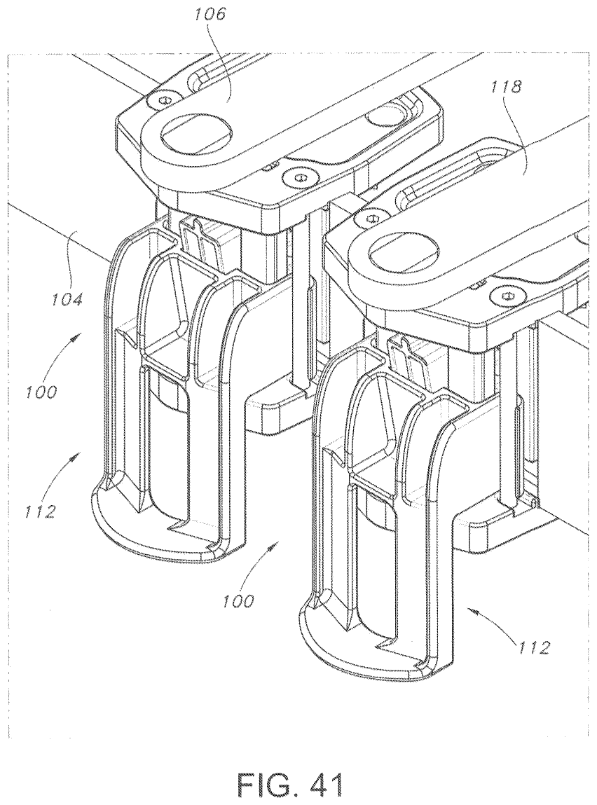

As indicated previously, a movable support 100 may be associated with each support arm, including a second support arm 118, as shown in FIG. 40. This movable support 100 need not include any retainer for fixing its position along the support rail, since it is connected by way of arms 106, 118 to the fixable support described above. This second support 100 may include one or more rollers 120 for facilitating low-friction rolling contact with the support rail (not shown), which would be located in opening Q. However, as indicated in FIG. 41, it is possible to provide each support 100 with a clamp 112, which may be used to independently fix it to the associated support rail 104.

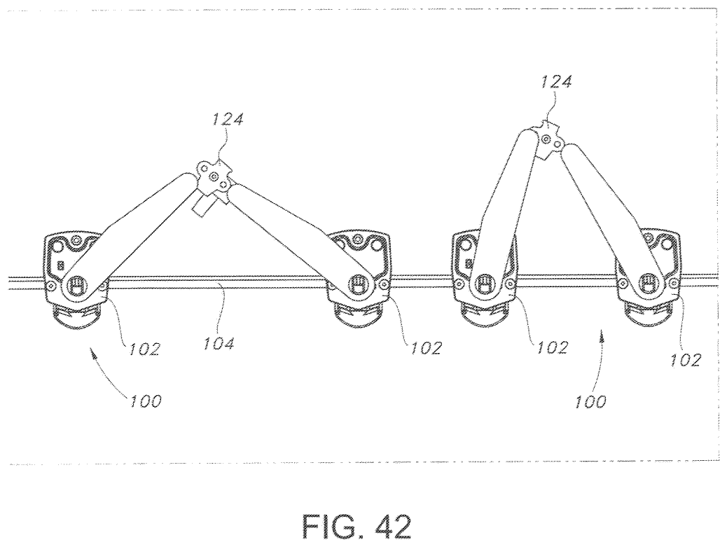

As can be understood with reference to FIG. 42, the above-described embodiment allows for each support 100 to be independently moved along the support rail 104 to a position (such as closer to each other or further apart from each other in the conveying direction) for positioning a guiderail connector, illustrated in the form of a receiver 124, associated with the respective support arms 106, 118 (which receiver 124 may include an extension 124a for engaging the support rail 104 in a collapsed condition of the support 100 to prevent it from bottoming out). In this manner, the relative positioning of the guiderail (not shown) may be independently and selectively adjusted by a user, and using a manual approach that avoids the need for power, motors, etc. Yet, the low-profile nature of the supports 100 is retained, which allows for a conveyor system to be provided which lacks the outwardly directed rods or like structures that can create various problems, as noted above.

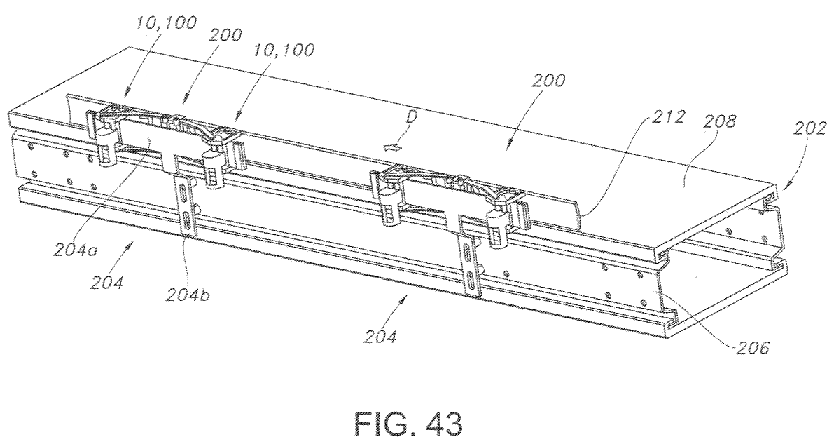

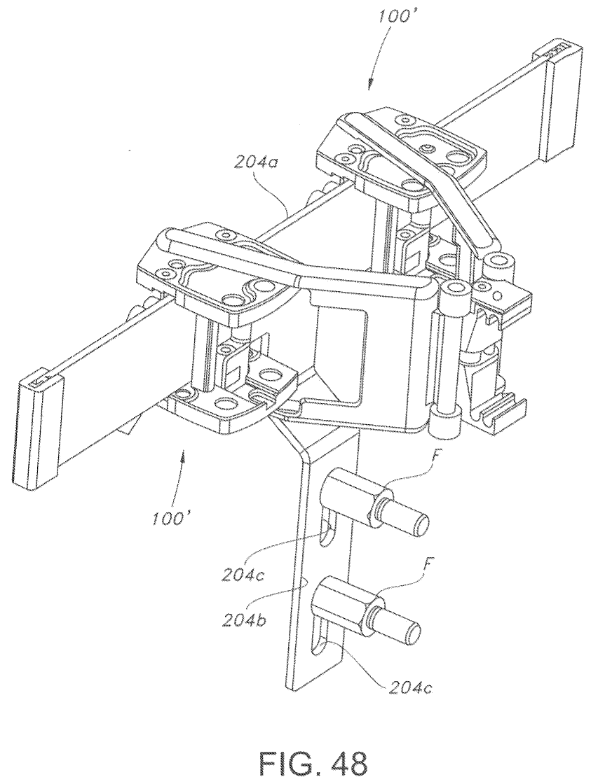

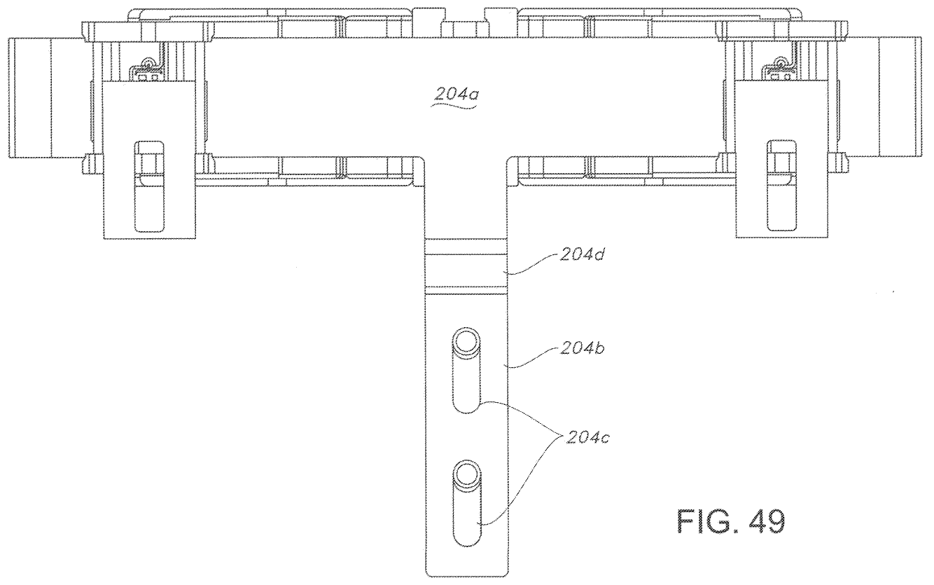

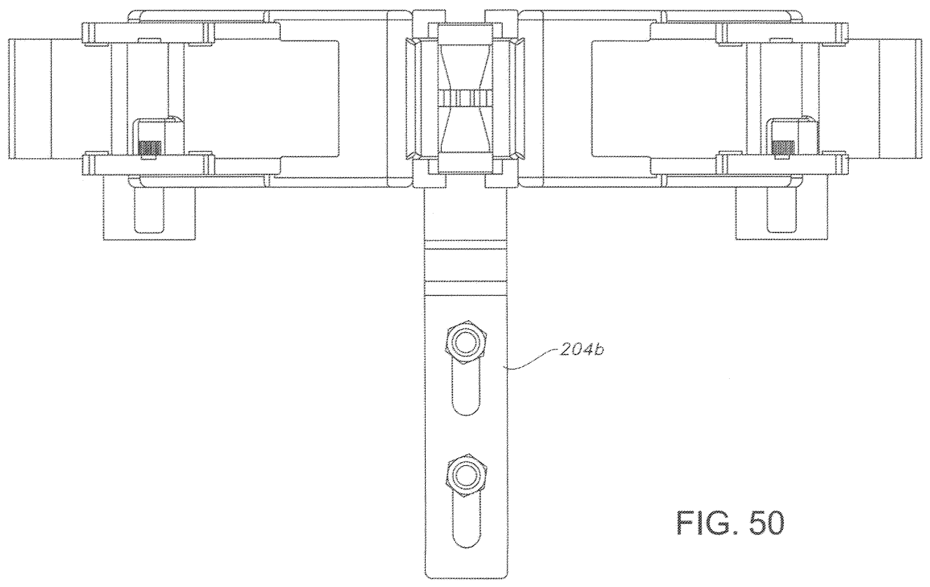

Turning to FIGS. 43-50, one or more mounts 200 may be provided for mounting an adjustable guiderail 212 from an associated conveyor 202. The mount(s) 200 may each comprise a low-profile bracket 204 adapted to connect to the conveyor 202. The connection may be along an external surface of a guiderail 206 for guiding a conveyor belt 208, possibly along an endless path including a forward or upper and lower or return run.

In the specific example, the bracket 204 is generally T-shaped, but could take other forms (H-shaped, inverted U-shaped, L-shaped), and in any case includes an upper portion 204a extending along the conveying surface, at or above the level of the conveying surface, and lower portion 204b depending therefrom for attachment to the guiderail 212. The lower portion 204b may be angled or sloped to place the horizontal portion outbound of the conveying surface, but it otherwise does not project outwardly from the conveyor 202 any significant distance (less than a few (<3) inches at most), and thus maintains the desired low profile. The vertical portion 204b may include elongated slots 204c for receiving one or more fasteners F for connecting the mount 200 to the conveyor 202, and thus allow for relative height adjustments to be made to the mount 200.

The upper portion 204a of the bracket 204 thus forms a support rail for supporting one or more of the adjusters or movable guiderail supports 10, 100 described above. As can be appreciated, the support rail formed by the upper portion 204a need extend only a sufficient distance in the conveying direction D to allow for the adjusters or supports 10, 100 to fully extend and retract the guiderail the desired distance into the conveying path, and thus need not extend the full distance of the conveyor 202. A resulting reduction in the use of materials as comparted to a full length support rail extending along the entire conveyor 202 saves costs, and also reduces weight and complexity.

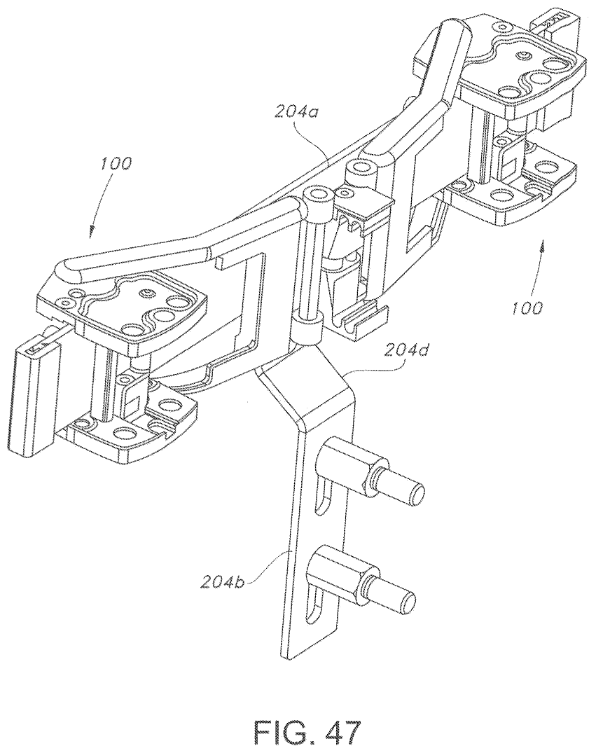

The upper portion 204a and lower portion 204b may also extend in different vertical planes, as shown in FIG. 47. This may be achieved by providing a bent portion 204d of the lower vertical portion 204b. In one version, as shown in FIG. 47, the bent portion 204d is such that the upper portion 204a, and hence the associated support(s), are arranged closer to the conveyor 202 as a result of this arrangement. In another version, as shown in FIG. 43, the bent portion 204d is such that the upper portion 204a is farther away from the conveyor 202, and hence the associated support(s) are so-positioned.

In the illustrated embodiment, each bracket 204 supports a pair of the supports 100 of the embodiment of FIGS. 35-42. The bracket 204 may also include one or more stops 210 at the end portion(s) for defining the maximum movement of the adjusters in a direction parallel to the conveying direction D of the belt 208 associated with conveyor 202. As can be appreciated, only one stop may achieve the desired result, since the supports 100 are connected to each other, and thus limiting the movement of one in the conveying direction will necessarily limit the movement of the other.

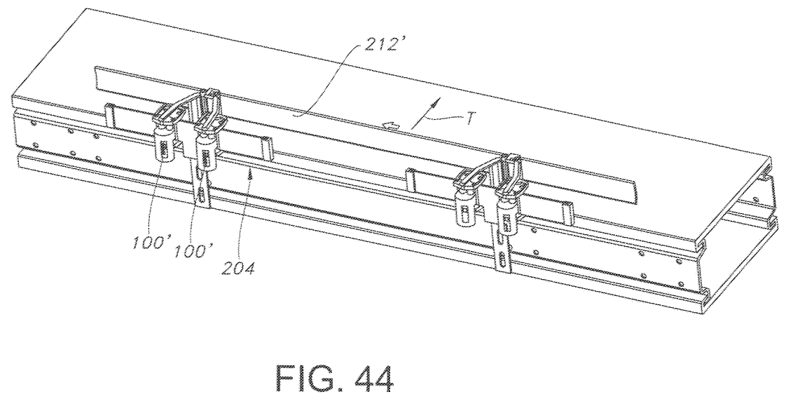

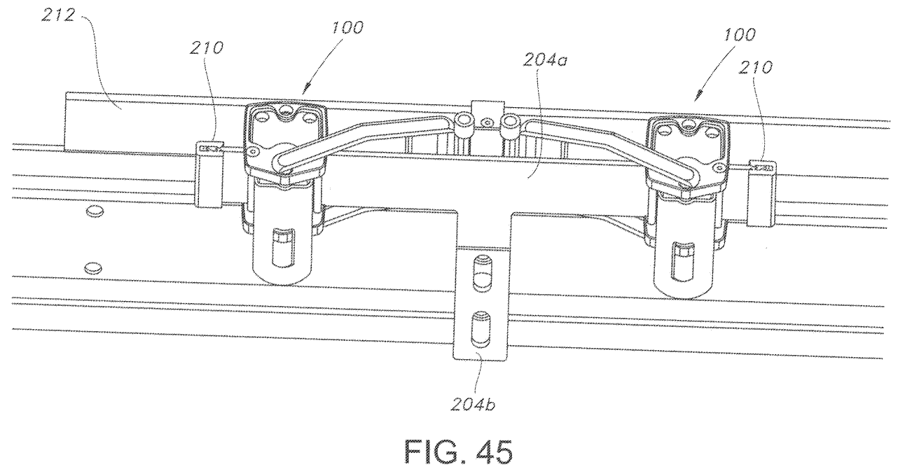

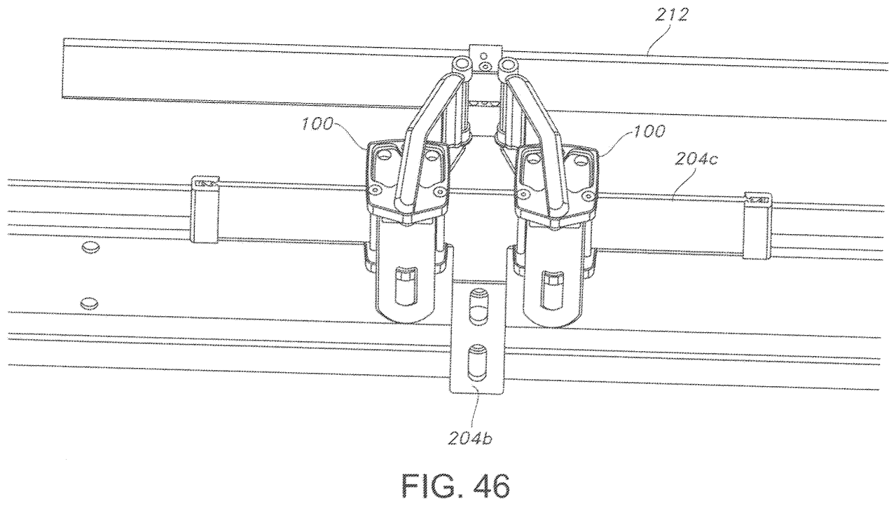

As perhaps best understood from FIGS. 45-46, the supports 100 may be adjusted to move the guiderail 212 toward and away from the bracket 204 (note transverse direction T) for defining the width of the conveying path (see position 212′ in FIG. 44, and note inner position of adjusters/supports 100), and then fixed into position on the bracket, such as by using the wedging action described above. Alternatively, the brackets 204 may be used in connection with adjusters 10 that are interconnected (such as by wire) and commonly actuated by an actuator (such as a motor). As can be appreciated, the adjustable guiderail may be provided on both sides of the belt 208, in which case a mount 204 could be provided on each side of the conveyor 202.

From FIGS. 45-46, it can also be understood that a relationship exists between the length of the upper portion 204a of the mount 200 and the extension of the guiderail 212. Specifically, the length of the upper portion 204a need only be such that the supports 100 are spaced farthest apart and located at or near the ends of this portion 204a (that is, adjacent to stops 210) when the guiderail 212 is at the fully inward position closest to the inner face of the upper portion 204a. Likewise, the supports 100 are moved toward and lie adjacent to the second portion 204b when the guiderail 212 is fully advanced towards or into the conveying path of the conveyor, as shown in FIG. 46. It can also be appreciated from FIGS. 45-46 that the lower portion 204b for attaching to the conveyor 202 is at all times located between the interconnected supports 100.

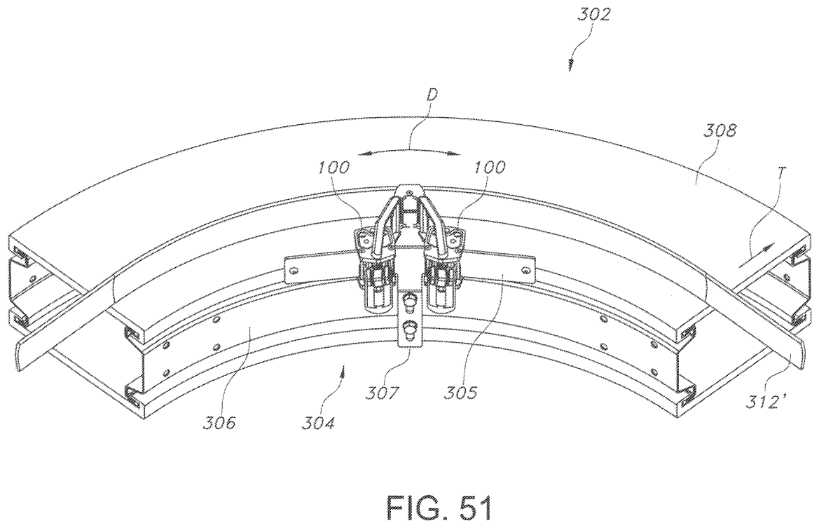

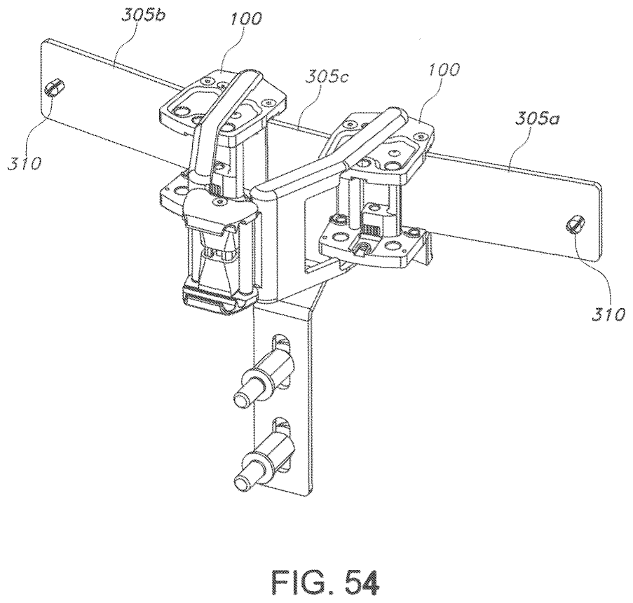

Turning to FIGS. 51-54, one or more mounts 300 may be provided for mounting an adjustable guiderail 312 from a curved conveyor 302. The mount(s) 300 may each comprise a bracket 304 adapted to connect to the conveyor 302, such as along an external surface of a guiderail 306 for guiding a conveyor belt 308, possibly along an endless path including a forward or upper and lower or return run. In the specific example, the bracket 304 is generally T-shaped, and includes an upper portion 305 extending at or above the level of the conveying surface, and lower vertical portion 307 depending therefrom for attachment to the guiderail 312 (which may be angled or sloped to place the horizontal portion outbound of the conveying surface, but otherwise does not project outwardly from the conveyor 302 any significant distance (less than a few (<3) inches at most), and thus maintains the desired low profile). Specifically, the vertical portion 307 may include elongated slots 307a for receiving one or more fasteners F for connecting the mount 300 to the conveyor 302.

In view of the curved nature of the conveyor 302, the upper portion 305 of the bracket 304 includes a matching curve or contour. This may be achieved by providing two bent portions 305a, 305b, which may project outwardly at an angle in opposite directions from a central portion 305c generally tangent to the curve of the conveyor 302. The upper portion 305 of the bracket 304 and, in particular, the bent portions 305a, 305b thus together form a support rail for supporting one or more of the adjusters 10, 100 described above. The support rail formed by the upper portion need extend only a sufficient distance in the conveying direction D (which is curved in view of the curved nature of the conveyor 302) to allow for the adjusters or supports 10, 100 to fully extend and retract the guiderail 312 the desired distance into the conveying path, and thus need not extend the full distance of the conveyor 302. A resulting reduction in the use of materials saves costs, and also reduces weight and complexity.

In the illustrated embodiment, each bracket 304 supports a pair of the supports 100 of the embodiment of FIGS. 35-42. The bracket 304 may also include one or more stops 310 at the end portion(s) for defining the maximum movement of the adjusters in a direction parallel to the conveying direction D of the belt 308 associated with conveyor 302. As can be appreciated, only one stop may achieve the desired result, since the supports 100 are connected to each other, and thus limiting the movement of one in the conveying direction will necessarily limit the movement of the other.

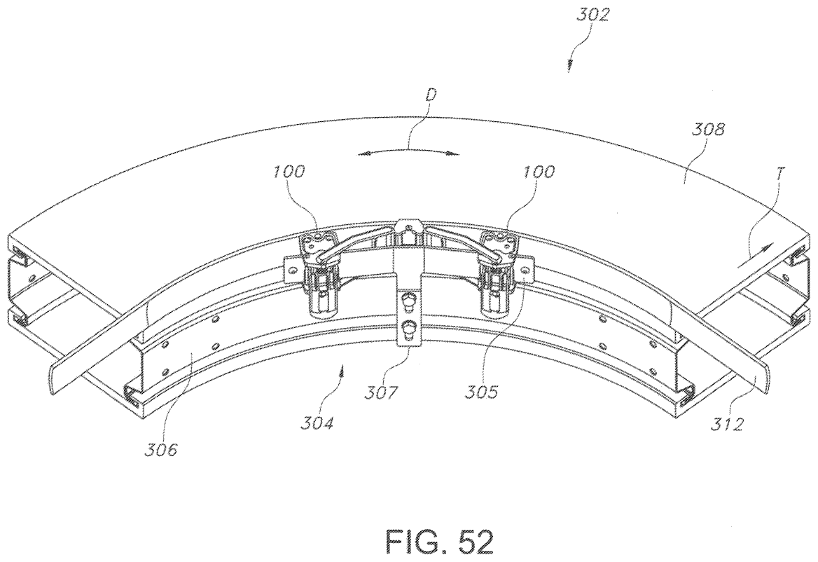

As perhaps best understood from FIGS. 51-52, the supports 100 may be adjusted to move the guiderail 312 toward and away from the bracket 304 (note transverse direction T) for defining the width of the conveying path (see position 312′ in FIG. 51, and note inner position of adjusters/supports 100), and then fixed into position on the bracket, such as by using the wedging action described above. Alternatively, the brackets 304 may be used in connection with adjusters 10 that are interconnected (such as by wire) and commonly actuated by an actuator (such as a motor). As can be appreciated, the adjustable guiderail 312 may be provided on both sides of the belt 308, in which case a mount 300 could be provided on each side of the conveyor 302.

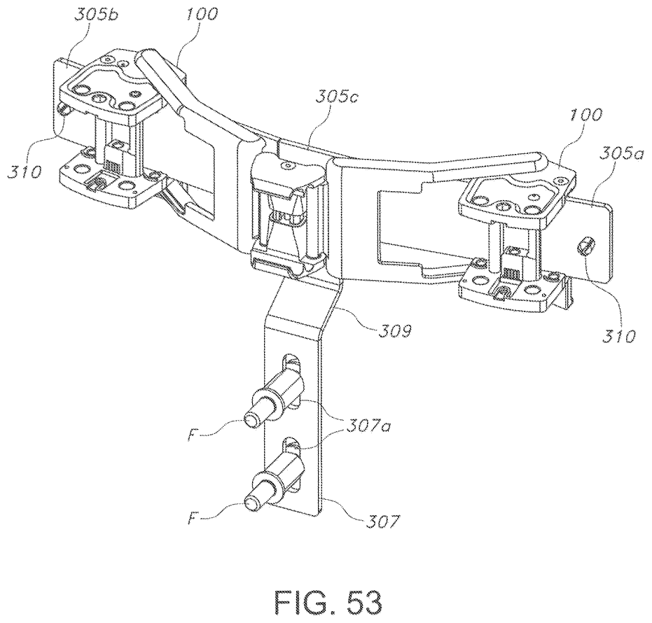

The upper portion 305 and lower portion 307 may also extend in different vertical planes, as shown in FIG. 53. This may be achieved by providing a bent portion 309 of the lower portion 307. In one version, as shown in FIG. 53, the bent portion 209 is such that the upper portion 305, and hence the associated support(s), are arranged closer to the conveyor 302 as a result of this arrangement. In another version (not shown), the bent portion 309 is such that the curved upper portion 305 is farther away from the conveyor 302, and hence the associated support(s) are so-positioned.

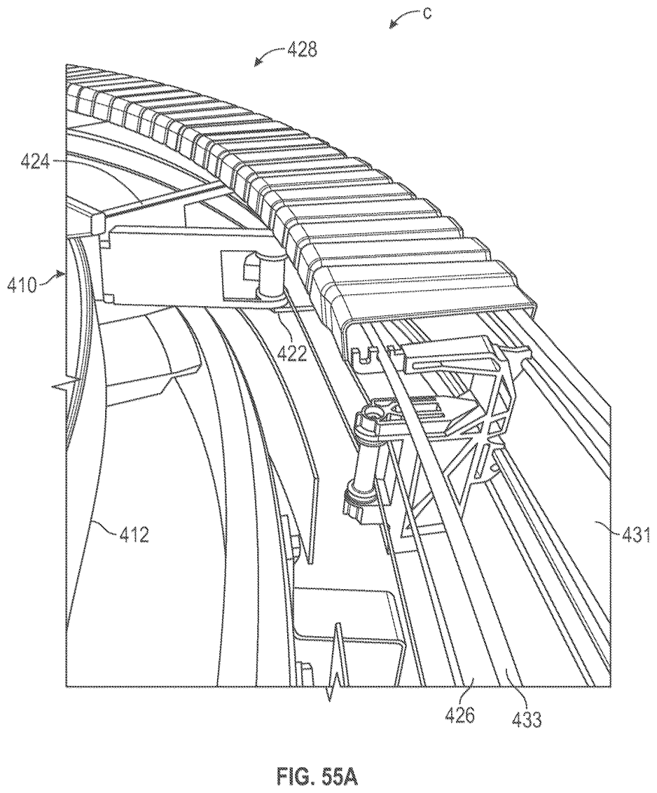

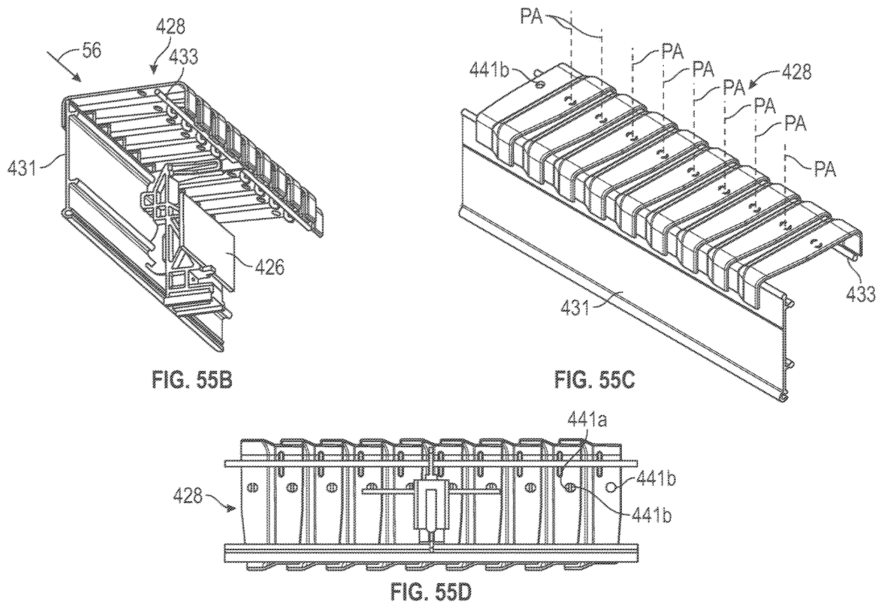

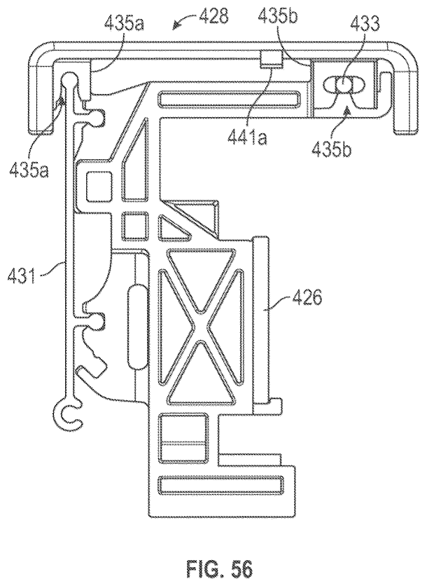

In FIG. 55A, a portion of a conveyor C is illustrated, wherein the conveyor C may be constructed as discussed above for the disclosed conveyors herein or may take other forms. In the illustrated non-limiting embodiment of FIG. 55A-55D, a cover 428 is provided for covering one or more components of the conveyor C, such as those used to support and/or adjust a guiderail 412 of the conveyor C, by way of example and without limitation. The covered components may include features associated with a guiderail actuator, such as adjuster 410, which may include a pair of shuttles 422, 424, a support rail 426, and/or a cable 444 used to drive the shuttles 422, 444 along the support rail 426, by way of example and without limitation. Further components may include guide brackets, also referred to as mount brackets 429, such as those that are used to guide the cable 444, as well as support a side shield, also referred to as side shroud 431, and a support rod, referred to hereafter as rod 433.

The cover 428 may comprise a plurality of segments 428a (best shown in FIGS. 57A-57D) coupled to one another for articulable movement relative to one another, and thus allow for ready customization. In the non-limiting embodiment illustrated, each of the segments 428a has at least one, and shown, by way of example and without limitation, as a pair of attachment features 435a, 435b to facilitate operably fixing the cover 428 over the component(s) of the conveyor C. In the non-limiting embodiment of the attachment features 435a, 435b illustrated, the attachment features 435a, 435b are snap-fit features.

In one example, the snap-fit features may comprise spring clips 435a, 435b having opposed spring fingers configured for snapping engagement with an upper edge of the side shroud 431 and the rod 433. At least one of spring clips 435b provides a lost-motion attachment, such that the rod 433, although received within in a snap-fit manner, and captured between the spring clip 435b, is able to move in lost-motion relation within an elongate slot 437 (best seen in FIG. 57D) extending between the opposed spring fingers of the spring clip 435b. The lost-motion of the rod 433 within the slot 437 facilitates articulated movement of the cover segments 428a relative to one another, thereby allowing the cover 428 to be routed freely along arcuate paths.

The plurality of segments 428a may be configured to overlap one another, thereby helping to avoid or prevent the passage of contamination, such as solid debris or otherwise, therethrough. Further yet, the overlapping segments 428a eliminate external access to pinch points created by the actuator or other components, thereby allowing a worker to work freely without concern of being inadvertently pinched. Accordingly, adjacent ones of the plurality of segments 428a are configured in partially overlying, nested relation with one another. The nested relation is provided via a slightly reduced size portion 439a (see FIGS. 57A-57C) of one cover segment 428a being received in telescoping relation within a slightly increased size portion 439b of the adjacent cover segment 428a.

The segments 428a may be coupled to one another by an interlockable interference fit. This interference fit in the illustrated non-limiting embodiment includes a single male part 441a and a single female part 441b spaced from one another. The male part 441a of one segment 428a is disposed in the female part 441b of the adjacent segment 428a to provide the pivoting, articulated movement of the adjacent segments 428a relative to one another about a pivot axis PA (FIG. 55C) extending through the male part 441a and the female part 441b.

Accordingly, the articulating movement is a pivoting movement about the single axis PA between the coupled cover segments 428a. In the non-limiting embodiment illustrated, the male parts 441a are provided by protrusions extending outwardly from the slightly increased size portion 439b of the walls of the segments 428a, and the female parts 441b are provided by openings in the slightly reduced size portion 439a of the walls of the cover segments 428a, wherein the male parts or protrusions 441a are configured for snapping engagement in the female parts or openings 441b, thereby allowing easy assembly without tools.

Each of the walls of the cover segments 428a may include an intermediate region 443 (FIG. 57A) having opposite edges 445 extending between opposite end regions 447. The opposite end regions 447 may extend in inclined relation from the intermediate region 443. In the non-limiting embodiment illustrated, the segments 428a are generally C-shaped, with the intermediate region 443 being a generally planar central region of the C-shape, and the opposite end regions 447 extending generally transversely from the intermediate region 443 to form opposite ends of the C-shape.

In the illustrated embodiment, the protrusions 441a and the openings 441b are formed in the intermediate region 443. A portion of the intermediate region 443 and a corresponding portion of the opposite end regions 447 of the one cover segment 428a are configured in nested relation with a portion of the intermediate region 443 and the corresponding portion of the opposite end regions 447 of the adjacent segments 428a forming the cover 428.

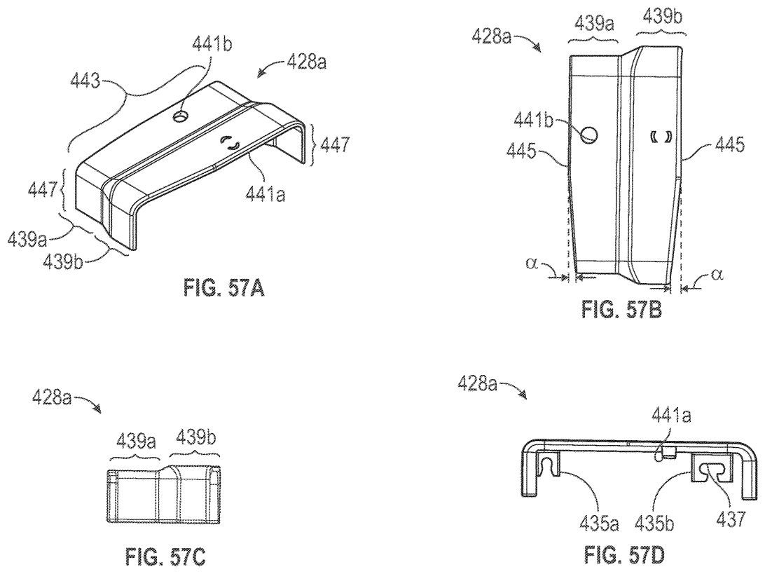

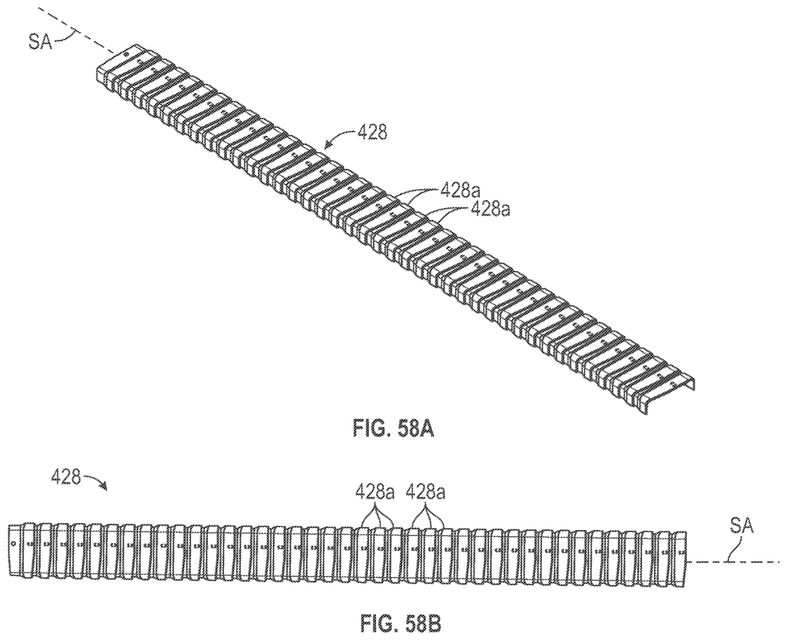

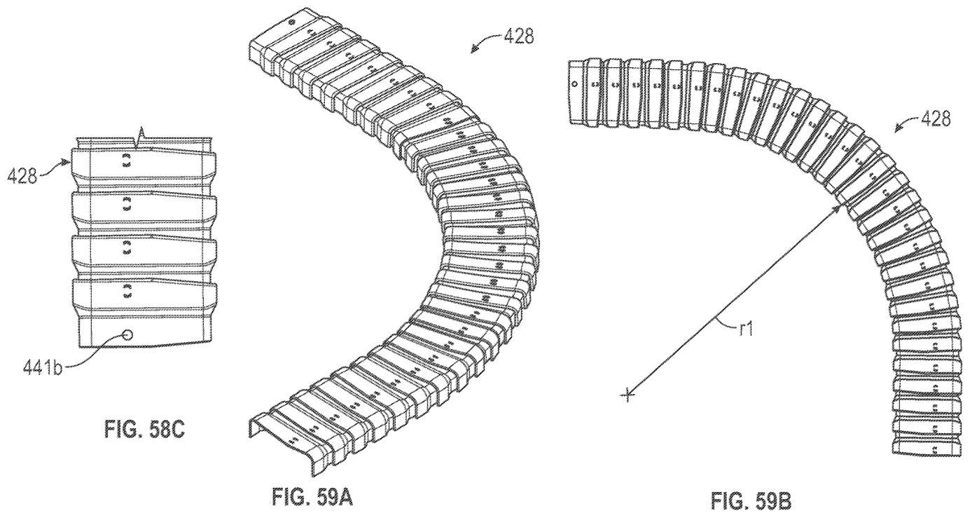

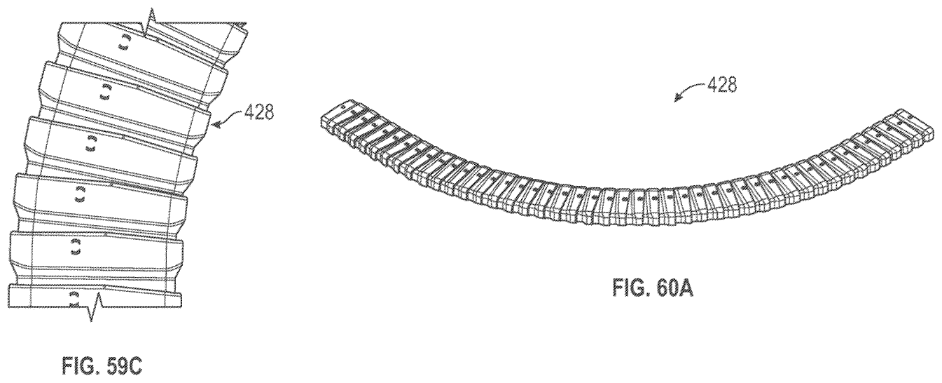

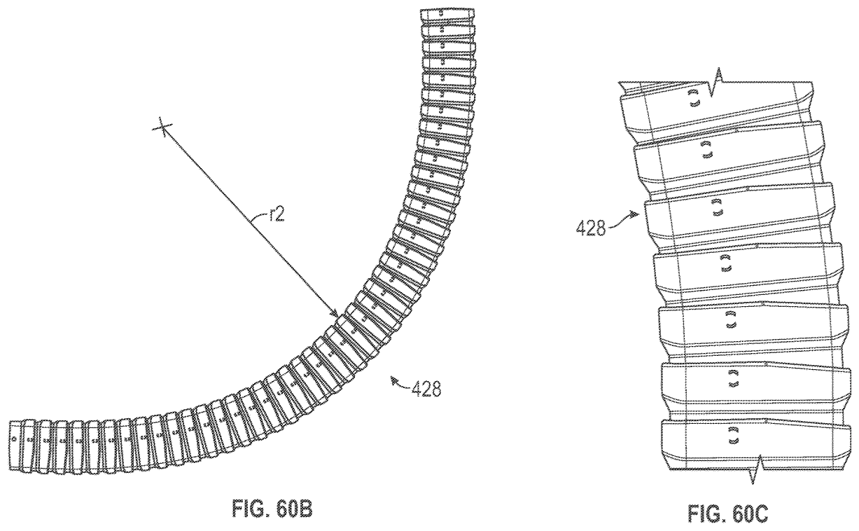

As illustrated in FIGS. 58A-58C, the segments 428a may be aligned along a straight axis SA to form the cover 428 as a linearly straight cover 428. As illustrated in FIGS. 59A-60C, the segments 428a are articulable relative to one another to form at least a portion of the cover 428 extending along an arcuate path (non-straight, curvilinear), wherein the arcuate path forms a circular arc. The segments 428a are articulable relative to one another to a maximum extent in a first direction, referred to as radially inwardly, to form the circular arc having a first radius of curvature r1 (FIGS. 59A-59C), and the segments 428a are articulated relative to one another to a maximum extent in a second direction, referred to as radially outwardly, opposite the first direction, to form the circular arc having a second radius of curvature r2 (FIGS. 60A-60C), wherein the first radius of curvature r1 is different than the second radius of curvature r2. In the illustrated non-limiting embodiment, the first radius of curvature r1 is less than the second radius of curvature r2, such that r1 forms a tighter curve as compared to the r2.

To be able to form the tighter curve of radius r1, the opposite edges 445 of the intermediate region 443 may be tapered to converge toward and to one of the opposite end regions 447 (FIG. 57B illustrates the taper, wherein the taper can be provided via a desire angle of inclination α. In accordance with one non-limiting embodiment, r1 can provide an internal diameter, such as 10 inches. The segments 428a may further be pivoted vertically relative to one another, and in accordance with one non-limiting embodiment, the cover 428 can be rolled vertically upward about a first diameter (e.g., about 19 inches), and rolled vertically downward about a second diameter (e.g., about 10 inches).

The segments 428a may be lightweight and economical in manufacture, such as via molding process. In a non-limiting aspect, the segments 428a may be formed via an injection molding process via injection of the desired type of plastic material to form the cover segments 428a. The segments 428a are also economical in assembly to form the cover 428, in the sense that no tools are needed to assembly the segments 428a to one another to form the cover 428, and it may be adjusted to a specific custom length by simply adding or removing segments. At least some, or all, of the segments 428a can be configured to facilitate operably fixing the cover 428 in overlying relation to the component(s) of the conveyor C desired to be covered.

In accordance with another aspect of the disclosure, a method of at least partially covering one or more components of a conveyor C is provided, which component may be a support for supporting an adjustable guiderail. The method incudes disposing a cover 428 having a plurality of cover segments 428a coupled to one another at least partially over the support. Further, the method may involve articulating at least some of the plurality of cover segments 428a relative to one another to route the cover 428 over an arcuate path. The method may further include articulating the cover segments 428a relative to one another about a pivot axis formed by interference fit features 441a, 441b that couple adjacent ones of the cover segments 428a to one another.

Summarizing, this disclosure may be considered to pertain to any or all of the following items in any combination:
1. An apparatus, comprising:
   a conveyor including a conveying surface for conveying one or more articles in a conveying direction;
   a guide rail for guiding the one or more articles during conveyance;
   a support for supporting the guide rail relative to the conveying surface; and
   a cover for at least partially covering the support, the cover comprising a plurality of segments adapted to interconnect and articulate relative to one another.
2. The apparatus of item 1, wherein adjacent segments of the plurality of segments overlap one another.
3. The apparatus of item 2, wherein the plurality of segments are coupled to one another by an interference fit.
4. The apparatus of item 3, wherein the interference fit includes a male part and a female part, and wherein the male part provided on a first segment and the female part is provided on an adjacent segment, and together provide the articulated movement of the first segment relative to the second segment.
5. The apparatus of item 4, wherein the male part is provided by a protrusion extending outwardly from a wall of the first segment, and the female part is provided by an opening in a wall of the second segment, wherein the protrusion is configured for a snap-fit engagement in the opening.
6. The apparatus of item 5, wherein the wall includes an intermediate region having opposite edges extending between opposite end regions, wherein the opposite end regions extend in inclined relation from the intermediate region.
7. The apparatus of item 5 or item 6, wherein the protrusion and the opening are formed in the intermediate region.
8. The apparatus of item 7, wherein the intermediate region and the opposite end region of the first segment are configured in nested relation with the intermediate region and the opposite end region of the second cover segment.
9. The apparatus of any of items 1-8, wherein each of the plurality of segments is generally C-shaped.
10. The apparatus of item 9, wherein the plurality of segments are adapted for assuming a first position in alignment along a straight axis to form the cover as a straight cover, and the plurality of segments are articulable relative to one another to form at least a portion of the cover extending along an arcuate path.
11. The apparatus of item 10, wherein the arcuate path is a circular arc.
12. The apparatus of item 11, wherein the plurality of segments are articulable relative to one another to a maximum extent in a first direction to form the circular arc having a first radius of curvature, and wherein the plurality of segments are articulable relative to one another to a maximum extent in a second direction, opposite the first direction, to form the circular arc having a second radius of curvature, wherein the first radius of curvature is different than the second radius of curvature.
13. The apparatus of item 12, wherein the opposite edges of the intermediate region converge toward one of the opposite end regions.
14. The apparatus of any of items 1-13, wherein at least some of the plurality of segments have at least one connector to facilitate connecting the cover in overlying relation to the support.
15. The apparatus of item 14, wherein the at least one connector comprises a snap fit connector.
16. The apparatus of item 15, wherein the snap-fit connector includes a pair of spring clips.
17. The apparatus of item 16, wherein one of spring clips forms a lost-motion attachment.
18. The apparatus of any of items 1-17, wherein the support comprises at least a portion of an actuator for actuating the guiderail for movement transverse to the conveying direction.
19. An apparatus for a conveyor including a conveying surface for conveying one or more articles in a conveying direction and associated with a guide rail for guiding the one or more articles and a support for supporting the guide rail relative to the conveying surface, comprising:
   a cover for at least partially covering the support, the cover comprising a plurality of segments adapted to interconnect and articulate relative to one another.
20. The apparatus of item 19, wherein adjacent segments of the plurality of segments overlap one another.
21. The apparatus of item 20, wherein the plurality of segments are coupled to one another by an interference fit.
22. The apparatus of item 21, wherein the interference fit includes a male part and a female part, and wherein the male part provided on a first segment is disposed in the female part of an adjacent segment to provide the articulated movement of the first segment relative to the second segment.
23. The apparatus of item 22, wherein the male part is provided by a protrusion extending outwardly from a wall of the first segment, and the female part is provided by an opening in a wall of the second segment, wherein the protrusion is configured for a snap-fit engagement in the opening.
24. The apparatus of item 23, wherein the wall includes an intermediate region having opposite edges extending between opposite end regions, wherein the opposite end regions extend in inclined relation from the intermediate region.
25. The apparatus of item 24, wherein the protrusion and the opening are formed in the intermediate region.
26. The apparatus of item 25, wherein the intermediate region and the opposite end region of the first cover segment are configured in nested relation with the intermediate region and the opposite end region of the second cover segment.
27. The apparatus of any of items 19-26, wherein each of the plurality of segments is generally C-shaped.
28. The apparatus of any of items 19-27, wherein the plurality of segments are adapted for assuming a first position in alignment along a straight axis to form the cover as a straight cover, and the plurality of segments are articulable relative to one another to form at least a portion of the cover extending along an arcuate path.
29. The apparatus of item 28, wherein the arcuate path is a circular arc.
30. The apparatus of item 29, wherein the plurality of segments are articulable relative to one another to a maximum extent in a first direction to form the circular arc having a first radius of curvature, and wherein the plurality of segments are articulable relative to one another to a maximum extent in a second direction, opposite the first direction, to form the circular arc having a second radius of curvature, wherein the first radius of curvature is different than the second radius of curvature.
31. The apparatus of item 24, wherein the opposite edges of the intermediate region converge toward one of the opposite end regions.
32. The apparatus of any of items 19-31, wherein at least some of the plurality of segments have at least one connector to facilitate connecting the cover in overlying relation to the support.
33. The apparatus of item 32, wherein the at least one connector comprises a snap fit connector.
34. The apparatus of item 33, wherein the snap-fit connector includes a pair of spring clips.
35. The apparatus of item 34, wherein one of spring clips forms a lost-motion attachment.
36. A method of covering a support for supporting a guide rail of a conveyor, comprising:
   at least partially covering the support with a cover having a plurality of segments coupled to one another; and
   articulating at least one of the plurality of segments relative to another to route the cover over an arcuate path.
37. The method of item 36, further including articulating the at least some of the plurality of segments relative to one another about a pivot axis formed by an interference fit that couple adjacent ones of the segments to one another.

Any elements described herein as singular can be pluralized (i.e., anything described as “one” can be more than one), and plural elements can be used individually. Characteristics disclosed of a single variation of an element, the device, the methods, or combinations thereof can be used or apply for other variations, for example, dimensions, shapes, materials, or combinations thereof. The terms “generally,” “substantially,” “about,” or “approximately” are meant to mean as close to the corresponding condition as reasonably possible, and typically not varying from it by more than 10%, unless circumstances indicate otherwise. Any species element of a genus element can have the characteristics or elements of any other species element of that genus. The term “comprising” is not meant to be limiting. The above-described configurations, elements or complete assemblies and methods and their elements for carrying out the invention, and variations of aspects of the invention can be combined and modified with each other in any combination.

The foregoing descriptions of various embodiments of a cover for a conveyor component and related methods provide illustration of the inventive concepts. The descriptions are not intended to be exhaustive or to limit the disclosed invention to the precise form disclosed. Modifications or variations are also possible in light of the above teachings. For instance, the connector forming a part of the actuator may comprise a flexible ribbon, which may be manually actuated by a lever or similar projecting piece by which a mechanism is operated or adjusted. While the shuttles 22, 24 are shown as overlying and sliding upon the support rail 26, the shuttles could also be recessed within cavities in the support rail 26, while still functioning as shuttles. The shuttles may also take different forms, such as for example elongated flexible ribbons connected to the arms 16, 18 and designed to move along the support rail 26 or within a cavity formed therein.

1. An apparatus, comprising:
a conveyor including a conveying surface for conveying one or more articles in a conveying direction;
a guide rail for guiding the one or more articles during conveyance;
a support for supporting the guide rail relative to the conveying surface; and
a cover for at least partially covering the support, the cover comprising a plurality of segments adapted to interconnect and articulate relative to one another.

2. The apparatus of claim 1, wherein adjacent segments of the plurality of segments overlap one another.

3. The apparatus of claim 2, wherein the plurality of segments are coupled to one another by an interference fit.

4. The apparatus of claim 3, wherein the interference fit includes a male part and a female part, and wherein the male part provided on a first segment and the female part is provided on an adjacent segment, and together provide the articulated movement of the first segment relative to the second segment.

5. The apparatus of claim 4, wherein the male part is provided by a protrusion extending outwardly from a wall of the first segment, and the female part is provided by an opening in a wall of the second segment, wherein the protrusion is configured for a snap-fit engagement in the opening.

6. The apparatus of claim 5, wherein the wall includes an intermediate region having opposite edges extending between opposite end regions, wherein the opposite end regions extend in inclined relation from the intermediate region.

7. The apparatus of claim 6, wherein the protrusion and the opening are formed in the intermediate region.

8. The apparatus of claim 7, wherein the intermediate region and the opposite end region of the first segment are configured in nested relation with the intermediate region and the opposite end region of the second segment.

9. The apparatus of claim 1, wherein each of the plurality of segments is generally C-shaped.

10. The apparatus of claim 9, wherein the plurality of segments are adapted for assuming a first position in alignment along a straight axis to form the cover as a straight cover, and the plurality of segments are articulable relative to one another to form at least a portion of the cover extending along an arcuate path.

11. The apparatus of claim 10, wherein the arcuate path is a circular arc.

12. The apparatus of claim 11, wherein the plurality of segments are articulable relative to one another to a maximum extent in a first direction to form the circular arc having a first radius of curvature, and wherein the plurality of segments are articulable relative to one another to a maximum extent in a second direction, opposite the first direction, to form the circular arc having a second radius of curvature, wherein the first radius of curvature is different than the second radius of curvature.

13. The apparatus of claim 12, wherein the opposite edges of the intermediate region converge toward one of the opposite end regions.

14. The apparatus of claim 1, wherein at least some of the plurality of segments have at least one connector to facilitate connecting the cover in overlying relation to the support.

15. The apparatus of claim 14, wherein the at least one connector comprises a snap fit connector.

16. The apparatus of claim 15, wherein the snap-fit connector includes a pair of spring clips.

17. The apparatus of claim 16, wherein one of spring clips forms a lost-motion attachment.

18. The apparatus of claim 1, wherein the support comprises at least a portion of an actuator for actuating the guiderail for movement transverse to the conveying direction.

19. An apparatus for a conveyor including a conveying surface for conveying one or more articles in a conveying direction and associated with a guide rail for guiding the one or more articles and a support for supporting the guide rail relative to the conveying surface, comprising:
a cover for at least partially covering the support, the cover comprising a plurality of segments adapted to interconnect and articulate relative to one another.

20. The apparatus of claim 19, wherein adjacent segments of the plurality of segments overlap one another.

21. The apparatus of claim 20, wherein the plurality of segments are coupled to one another by an interference fit.

22. The apparatus of claim 21, wherein the interference fit includes a male part and a female part, and wherein the male part provided on a first segment is disposed in the female part of an adjacent segment to provide the articulated movement of the first segment relative to the second segment.

23. The apparatus of claim 22, wherein the male part is provided by a protrusion extending outwardly from a wall of the first segment, and the female part is provided by an opening in a wall of the second segment, wherein the protrusion is configured for a snap-fit engagement in the opening.

24. The apparatus of claim 23, wherein the wall includes an intermediate region having opposite edges extending between opposite end regions, wherein the opposite end regions extend in inclined relation from the intermediate region.

25. The apparatus of claim 24, wherein the protrusion and the opening are formed in the intermediate region.

26. The apparatus of claim 25, wherein the intermediate region and the opposite end region of the first segment are configured in nested relation with the intermediate region and the opposite end region of the second segment.

27. The apparatus of claim 19, wherein each of the plurality of segments is generally C-shaped.

28. The apparatus of claim 19, wherein the plurality of segments are adapted for assuming a first position in alignment along a straight axis to form the cover as a straight cover, and the plurality of segments are articulable relative to one another to form at least a portion of the cover extending along an arcuate path.

29. The apparatus of claim 28, wherein the arcuate path is a circular arc.

30. The apparatus of claim 29, wherein the plurality of segments are articulable relative to one another to a maximum extent in a first direction to form the circular arc having a first radius of curvature, and wherein the plurality of segments are articulable relative to one another to a maximum extent in a second direction, opposite the first direction, to form the circular arc having a second radius of curvature, wherein the first radius of curvature is different than the second radius of curvature.

31. The apparatus of claim 24, wherein the opposite edges of the intermediate region converge toward one of the opposite end regions.

32. The apparatus of claim 19, wherein at least some of the plurality of segments have at least one connector to facilitate connecting the cover in overlying relation to the support.

33. The apparatus of claim 32, wherein the at least one connector comprises a snap fit connector.

34. The apparatus of claim 33, wherein the snap-fit connector includes a pair of spring clips.

35. The apparatus of claim 34, wherein one of spring clips forms a lost-motion attachment.

36. A method of covering a support for supporting a guide rail of a conveyor, comprising:
at least partially covering the support with a cover having a plurality of segments coupled to one another; and
articulating at least one of the plurality of segments relative to another to route the cover over an arcuate path.

37. The method of claim 36, further including articulating the at least some of the plurality of segments relative to one another about a pivot axis formed by an interference fit that couple adjacent ones of the segments to one another.
